(19) United States
(12) Patent Application Publication
(10) Pub. No.: US 2026/0342557 A1
(43) Pub. Date: Oct. 29, 2026

(54) SYSTEM AND METHOD FOR GENERATING IDENTITY-ANCHORED BIOMETRICS-BASED CREDENTIAL KEYS

(71) Applicant: Amod Ashok Dange, Mountain View, CA (US)

(72) Inventor: Amod Ashok Dange, Mountain View, CA (US)

(21) Appl. No.: 19/719,339

(22) Filed: Jun. 25, 2026

Related U.S. Application Data
(63) Continuation-in-part of application No. 19/050,160, filed on Feb. 11, 2025.
Application No. 19/050,160 is a continuation-in-part of application No. 18/782,801, filed on Jul. 24, 2024, now Pat. No. 12,603,780.
Application No. 18/782,801 is a continuation-in-part of application No. 17/481,468, filed on Sep. 22, 2021, now Pat. No. 12,072,963.
Application No. 17/481,468 is a continuation-in-part of application No. 17/018,273, filed on Sep. 11, 2020, now Pat. No. 11,582,032.
(60) Provisional application No. 62/906,080, filed on Sep. 25, 2019.
(60) Provisional application No. 62/954,591, filed on Dec. 29, 2019.
(60) Provisional application No. 63/029,717, filed on May 26, 2020.

(51) Int. Cl. H04L 9/08; H04L 9/32

(52) U.S. Cl. CPC H04L 9/0866; H04L 9/3231; H04L 9/3247

(57) ABSTRACT

A system and method for generating identity-anchored biometrics-based credential keys. A credential private key is generated by and held within a hardware security module (HSM) of a mobile device, hardware-bound and non-extractable. An application processor computes, transiently and without persisting any biometric template: a proprietary biometric key (PBK) by processing a real-time biometric sample; and a deterministic document hash (DocHash) by hashing canonicalized attribute fields of an identity-anchor record. The application processor applies a key derivation function with the PBK as input key material and the DocHash as salt to derive a credential wrapping key (CWK), which is then used to wrap a credential record referencing the HSM-resident private key. The DocHash simultaneously serves as a Sybil-resistance deduplication anchor on a relying party server, and as a cross-device recovery anchor enabling automated account migration on a new device without server-side key backup.

### CROSS-REFERENCE TO RELATED APPLICATIONS AND PRIORITY

The present application is a Continuation in Part (CIP) application of U.S. nonprovisional application Ser. No. 19/050,160, filed on Feb. 11, 2025 entitled “System and method for generating hidden biometrics-based passwords”, which claims the benefit of and is a CIP of the U.S. nonprovisional application Ser. No. 18/782,801, filed on Jul. 24, 2024 entitled “System and method for managing an operating system using tokenized identity”, which claims the benefit of and is a CIP of U.S. nonprovisional application Ser. No. 17/481,468, filed on Sep. 22, 2021 entitled “System and method for affixing a signature using biometric authentication”, which claims the benefit of and is a CIP of U.S. Complete application Ser. No. 17/018,273 filed on Sep. 11, 2020 entitled “System and method for sharing user preferences without having the user reveal their identity”, which claims the benefit of U.S. Provisional Application No. 62/906,080 filed on Sep. 25, 2019 entitled “Method and system of managing personal and business information”, the U.S. Provisional Application No. 62/954,591 filed on Dec. 29, 2019 entitled “Method and system for anonymously matching consumers and businesses”, and also the U.S. Provisional Application No. 63/029,717 filed on May 26, 2020 entitled “Method and system of storing identity and signature using the human body as a node.”

### TECHNICAL FIELD

The present subject matter described herein, in general, relates to computer-implemented cryptographic key derivation systems and FIDO2 passkey authentication and other asymmetric authentication credential architectures. More specifically, the present subject matter pertains to a system and method for generating and managing a credential private key whose private half is held in a hardware security module of a mobile device such that the private half is hardware-bound and non-extractable, and whose use is bound to a composite of biometric-derived key material and a deterministic hash of identity-anchor record fields, wherein the biometric-derived key material and the document hash are computed by an application processor of the mobile device in transient volatile memory of an application's process without persisting biometric templates, while enabling cross-device credential recovery and serving simultaneously as both an authentication credential and an identity deduplication anchor for Sybil resistance.

### BACKGROUND

The following description of related art is intended to provide background information pertaining to the field of the invention. This section may include certain aspects of the art that may be related to various features of the present invention. However, it should be appreciated that this section be used only to enhance the understanding of the reader with respect to the present invention, and not as admissions of prior art.

The FIDO2 (Fast Identity Online 2) standard, encompassing WebAuthn and CTAP2 protocols, has emerged as the dominant framework for passwordless authentication on modern computing devices. Current FIDO2 implementations deploy credential private keys within hardware security modules, such as the Apple Secure Enclave or Android StrongBox Keystore, providing strong cryptographic authentication with high usability. These implementations generate credential private keys using cryptographically secure random number generators, ensuring that each credential is unique and resistant to brute-force attacks. The credential private key is used to sign WebAuthn attestation and assertion objects, which are transmitted to a relying party server for verification against the corresponding credential public key. The relying party server stores credential public keys indexed by user identifiers, and verifies ECDSA or RSA signatures on each authentication ceremony.

However, existing FIDO2 implementations face fundamental technical limitations in their cryptographic architecture. The use of purely random key generation introduces an inherent disconnection between the credential private key and the identity of the user who controls it. This randomness-based approach provides no intrinsic mechanism to bind the cryptographic credential to the physical identity of the user, making it computationally infeasible to determine whether two distinct FIDO2 credentials belong to the same individual. In systems requiring Sybil resistance—such as decentralized identity networks, digital financial platforms, and anti-fraud architectures—randomly generated FIDO2 keys offer no computational mechanism to prevent a single individual from registering multiple credentials across different accounts. The existing architecture requires additional identity verification layers, introducing dual cryptographic flows, increased computational overhead, additional network round-trips for out-of-band verification, and expanded storage requirements on the relying party server for separate identity proofs alongside FIDO2 credentials.

Furthermore, existing FIDO2 passkey recovery mechanisms present significant technical challenges in maintaining credential continuity across devices. Current recovery approaches either rely on server-side backup of the credential private key, which undermines the fundamental security model of FIDO2 by centralizing cryptographic key material on remote servers exposed to network-based attacks, or require manual credential re-enrollment on new devices without any cryptographic mechanism to verify that the same physical person is registering the replacement credential. This creates a vulnerability wherein the credential recovery process cannot computationally distinguish between a legitimate recovery attempt by the original user and an unauthorized credential registration by an attacker who has gained access to the user's account. Additionally, contemporary biometric-based key derivation systems that have been proposed to address these limitations often persist biometric templates—either on the device's non-volatile storage or on a remote server—to enable matching or recovery. The persistence of biometric templates introduces irreversible security risks, as compromised biometric templates cannot be revoked or regenerated unlike passwords or cryptographic keys, and may be linked across multiple systems through template matching, enabling cross-system biometric surveillance. These persistent templates create high-value attack targets, and their compromise results in permanent exposure of biometric characteristics that the user cannot change.

Prior attempts to bridge the gap between FIDO2 authentication and identity verification have layered identity verification mechanisms on top of the FIDO2 credential lifecycle. Approaches based on Verifiable Credentials (W3C VC format) and similar off-chain identity proofs require the relying party to process and verify separate identity assertions alongside FIDO2 authentication, introducing additional computational overhead, separate cryptographic verification flows, and expanded server-side storage for identity proofs. The FIDO Device Onboard (FDO) specifications and related work in Verifiable Passkeys propose attestation-based approaches that cryptographically bind device identity to the FIDO2 credential, but these attestation mechanisms verify device provenance rather than user identity, and do not provide Sybil resistance at the individual level. Zero-knowledge proof-based identity systems offer privacy-preserving identity verification but require computationally expensive proof generation and verification operations, often exceeding the processing capabilities of mobile hardware security modules within acceptable latency constraints for real-time authentication ceremonies. None of the existing approaches combine the credential private key derivation process with identity document verification in a manner that simultaneously provides both authentication and identity deduplication within a single cryptographic construction.

Therefore, there exists a technical need for a computer-implemented system and method that binds use of a credential private key, held within a hardware security module, to a composite of biometric-derived cryptographic key material and a deterministic hash of identity-anchor record fields computed in transient application-processor memory, without persisting biometric templates to non-volatile storage, while simultaneously providing Sybil resistance through the identity-anchor record hash serving as a deduplication anchor on the relying party server, and enabling cross-device credential recovery through deterministic regeneration of the identity-anchor record hash on a replacement device without requiring server-side backup of the credential private key.

Within the family of related applications to which the present application claims priority, including without limitation U.S. patent application Ser. No. 19/050,160 (entitled “System and Method for Generating Hidden Biometrics-Based Passwords”), U.S. patent application Ser. No. 18/782,801 (entitled “System and Method for Managing an Operating System Using Tokenized Identity,” granted as U.S. Pat. No. 12,603,780), U.S. Pat. Nos. 12,072,963, and 11,582,032, a biometric-authentication construct has been disclosed wherein a Secret-Key (S1) is computed by an application processor of a mobile device by processing one or more biometric samples captured from a user; a Unique-Number (N1) is obtained; a Function (F1) is applied to the Secret-Key (S1) and the Unique-Number (N1) to compute a Public-Key (P1), such that P1=F1(S1, N1); the Unique-Number (N1) is stored on the user's mobile device and the Public-Key (P1) is stored on a storage device accessible to the system; and user authentication is subsequently performed by capturing a fresh biometric sample, processing the fresh biometric sample to compute a Secret-Key (S2), retrieving the stored Public-Key (P1), computing a Real-Time-Unique-Number (N2) using the Public-Key (P1), the Secret-Key (S2), and the Function (F1), and comparing the Real-Time-Unique-Number (N2) with the stored Unique-Number (N1) to authenticate the user. In the priority applications, the Unique-Number (N1) is generated using a random number generation algorithm, which is suitable for many authentication contexts but does not, by itself, provide a mechanism for Sybil resistance through deduplication at a relying party server, nor a mechanism for cross-device credential recovery through deterministic regeneration of authentication material on a replacement device, nor an intrinsic binding of the resulting Public-Key (P1) to a hardware-bound credential private key held within a hardware security module. The present application discloses a refinement of the biometric-authentication construct of the priority applications in which the Unique-Number (N1) is implemented as a deterministic document hash (DocHash) computed from canonicalized attribute fields of an identity-anchor record, the Function (F1) is implemented as a key derivation function, the Public-Key (P1) is implemented as a credential wrapping key (CWK) used to wrap a credential record referencing a hardware-bound credential private key (CPK) held within a hardware security module of the mobile device, and the resulting deterministic document hash (DocHash) serves simultaneously as (i) a Sybil-resistance deduplication anchor on a relying party server and (ii) a cross-device identity anchor enabling automated account migration without server-side key backup.

### SUMMARY

This summary introduces concepts related to a system and method for generating identity-anchored biometrics-based credential keys, which are further described in the detailed description. This summary is not intended to identify essential features of the claimed subject matter nor is it intended for use in determining or limiting the scope of the claimed subject matter.

In one implementation, a system for generating identity-anchored biometrics-based credential keys is disclosed. The system comprises a mobile device comprising a biometric sensor, an application processor, a hardware security module, and an identity-anchor record acquisition module. The system further comprises a network communicatively coupling the mobile device to a relying party server. The relying party server comprises a credential verification module, a deduplication database, and an account store. The application processor is configured to execute programmed instructions for capturing, by the biometric sensor, a biometric sample from a user in real-time.

The application processor is further configured to execute programmed instructions for computing, by the application processor in transient volatile memory of the application's process, a proprietary biometric key (PBK) by processing the captured biometric sample, wherein the computed proprietary biometric key (PBK) is retained only in transient volatile memory of the application's process, is zeroized immediately after derivation therefrom of the credential wrapping key (CWK), and is not persisted to non-volatile storage. The application processor is further configured to execute programmed instructions for extracting, by the identity-anchor record acquisition module, attribute fields from an identity-anchor record, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer, wherein the attribute fields are selected such that, in combination, they deterministically distinguish the individual from other individuals within a relevant population. The application processor is further configured to execute programmed instructions for canonicalizing the extracted attribute fields by application of a canonicalization procedure adapted to a serialization format of the identity-anchor record, the canonicalization procedure comprising one or more operations selected from normalizing whitespace, handling diacritics, applying uniform case conversion, JSON-LD canonicalization in accordance with URDNA2015, CBOR-deterministic encoding in accordance with RFC 8949 Section 4.2.1, and a combination of the foregoing, to produce canonicalized attribute fields. The application processor is further configured to execute programmed instructions for computing a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator, wherein the computed document hash (DocHash) is deterministic such that a same identity-anchor record produces a same document hash (DocHash). The application processor is further configured to execute programmed instructions for deriving, by the application processor in transient volatile memory of the application's process, a credential wrapping key (CWK) by applying a key derivation function with the computed proprietary biometric key (PBK) as input key material, the computed document hash (DocHash) as salt, and context information comprising a relying party identifier and a user handle as an info parameter, wherein the derived credential wrapping key (CWK) is retained only in transient volatile memory of the application's process and is zeroized immediately after use. The application processor is further configured to execute programmed instructions for generating, by the hardware security module, a credential private key (CPK) such that the private half of the credential private key (CPK) is hardware-bound, non-extractable, and never leaves the hardware security module in plaintext, and binding use of the credential private key (CPK) to a combination of the computed proprietary biometric key (PBK), the computed document hash (DocHash), and the relying party identifier by means of the derived credential wrapping key (CWK), wherein the binding is established by the application processor as further described herein. The application processor is further configured to execute programmed instructions for signing an attestation object using the generated credential private key (CPK), the attestation object comprising a credential public key derived from the credential private key (CPK). The application processor is further configured to execute programmed instructions for transmitting the signed attestation object and the computed document hash (DocHash) to the relying party server via the network. The relying party server is configured to verify, by the credential verification module, the transmitted attestation object. The relying party server is further configured to store the computed document hash (DocHash) in the deduplication database and the credential public key in the account store. The relying party server is further configured to check the deduplication database upon a credential registration attempt to reject registration when the computed document hash (DocHash) matches an existing entry in the deduplication database, thereby preventing a single individual from registering multiple accounts.

In another implementation, a method for generating identity-anchored biometrics-based credential keys is disclosed. The method comprises steps of receiving, by a relying party server, a credential creation request comprising a challenge, a relying party identifier, and user information, and transmitting the credential creation request to a mobile device via a network. The method further comprises steps of capturing, by the mobile device, a biometric sample from a user in real-time using a biometric sensor, computing, by an application processor of the mobile device in transient volatile memory of an application's process, a proprietary biometric key (PBK) by processing the captured biometric sample, and wherein the computed proprietary biometric key (PBK) is retained only in transient volatile memory of the application's process and is zeroized immediately after derivation therefrom of a credential wrapping key (CWK). The method further comprises steps of extracting, by the mobile device using an identity-anchor record acquisition module, attribute fields from an identity-anchor record, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer, wherein the attribute fields are selected such that, in combination, they deterministically distinguish the individual from other individuals within a relevant population, canonicalizing the extracted attribute fields by application of a canonicalization procedure adapted to a serialization format of the identity-anchor record, and computing a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator, wherein the computed document hash (DocHash) is deterministic such that a same identity-anchor record produces a same document hash (DocHash). The method further comprises steps of deriving, by the application processor in transient volatile memory of the application's process, a credential wrapping key (CWK) by applying a key derivation function with the computed proprietary biometric key (PBK) as input key material, the computed document hash (DocHash) as salt, and context information comprising the relying party identifier and a user handle as an info parameter, wherein the derived credential wrapping key (CWK) is retained only in transient volatile memory of the application's process and is zeroized immediately after use. The method further comprises steps of generating, by the hardware security module, a credential private key (CPK) such that the private half of the credential private key (CPK) is hardware-bound, non-extractable, and never leaves the hardware security module in plaintext, and binding use of the credential private key (CPK) to a combination of the computed proprietary biometric key (PBK), the computed document hash (DocHash), and the relying party identifier by means of the derived credential wrapping key (CWK). The method further comprises steps of creating an attestation object comprising a credential public key derived from the generated credential private key (CPK) and signing the attestation object using the credential private key (CPK). The method further comprises steps of receiving, by the relying party server, the signed attestation object and the computed document hash (DocHash), verifying the signed attestation object using a credential verification module, storing the computed document hash (DocHash) in a deduplication database and the credential public key in an account store, and checking the deduplication database upon a credential registration attempt to reject registration when the computed document hash (DocHash) matches an existing entry in the deduplication database, thereby preventing a single individual from registering multiple accounts.

In yet another implementation, a computer program product for generating identity-anchored biometrics-based credential keys is disclosed. The computer program product comprises a non-transitory computer-readable storage medium having program instructions embodied therewith, wherein the program instructions are executable by an application processor of a mobile device equipped with a biometric sensor, a hardware security module, and an identity-anchor record acquisition module. The program instructions are executable for capturing a biometric sample from a user in real-time using the biometric sensor, computing, by the application processor in transient volatile memory of an application's process, a proprietary biometric key (PBK) by processing the captured biometric sample, and wherein the computed proprietary biometric key (PBK) is retained only in transient volatile memory of the application's process and is zeroized immediately after use. The program instructions are further executable for extracting, via the identity-anchor record acquisition module, attribute fields from an identity-anchor record, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer, wherein the attribute fields are selected such that, in combination, they deterministically distinguish the individual from other individuals within a relevant population, canonicalizing the extracted attribute fields by application of a canonicalization procedure adapted to a serialization format of the identity-anchor record, and computing a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator. The program instructions are further executable for deriving, by the application processor in transient volatile memory of the application's process, a credential wrapping key (CWK) by applying a key derivation function with the computed proprietary biometric key (PBK) as input key material, the computed document hash (DocHash) as salt, and context information comprising a relying party identifier and a user handle, wherein the derived credential wrapping key (CWK) is retained only in transient volatile memory of the application's process and is zeroized immediately after use. The program instructions are further executable for generating, by the hardware security module, a credential private key (CPK) such that the private half of the credential private key (CPK) is hardware-bound, non-extractable, and never leaves the hardware security module in plaintext, binding use of the credential private key (CPK) to a combination of the computed proprietary biometric key (PBK), the computed document hash (DocHash), and the relying party identifier by means of the derived credential wrapping key (CWK), creating an attestation object comprising a credential public key derived from the credential private key (CPK), signing the attestation object, and transmitting the signed attestation object and the computed document hash (DocHash) to a relying party server via a network for verification and storage, wherein the relying party server stores the computed document hash (DocHash) in a deduplication database and checks the deduplication database upon a credential registration attempt to reject registration when the computed document hash (DocHash) matches an existing entry, thereby preventing a single individual from registering multiple accounts.

The foregoing general description of the illustrative embodiments and the following detailed description thereof are merely exemplary aspects of the teachings of this invention, and are not restrictive.

### BRIEF DESCRIPTION OF DRAWINGS

The detailed description is described with reference to the accompanying Figures. The same numbers are used throughout the drawings to refer to features and components.

FIG. 1 illustrates a system architecture overview of a system for generating identity-anchored biometrics-based credential keys, in accordance with an embodiment of the present invention;

FIG. 2 illustrates a key derivation pipeline showing the biometric path and the document path for deriving a credential private key, in accordance with an embodiment of the present invention;

FIG. 3 illustrates a credential creation ceremony corresponding to a WebAuthn credential creation flow, in accordance with an embodiment of the present invention;

FIG. 4 illustrates an authentication ceremony corresponding to a WebAuthn assertion flow, in accordance with an embodiment of the present invention;

FIG. 5 illustrates a cross-device recovery flow showing device replacement and account migration, in accordance with an embodiment of the present invention;

FIG. 6 illustrates a deduplication mechanism for Sybil resistance showing first registration and duplicate attempt rejection, in accordance with an embodiment of the present invention; and

FIG. 7 illustrates an alternative embodiment using an Android StrongBox Keystore as the hardware security module, in accordance with an embodiment of the present invention.

The foregoing shall be more apparent from the following more detailed description of the invention.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures, or characteristics may be combined in any suitable manner in one or more embodiments.

The following description provides exemplary embodiments for illustrative purposes and is not intended to limit the scope or applicability of the invention. Various specific details are provided to enable thorough understanding, but embodiments may be practiced without these details. Well-known processes, structures, and techniques may be shown without unnecessary detail to avoid obscuring the embodiments. The terms “exemplary” or “demonstrative” mean serving as an example and are not necessarily preferred or advantageous over other designs. References to “one embodiment” or “an embodiment” throughout this specification do not necessarily refer to the same embodiment, and particular features may be combined in any suitable manner. As used herein, singular forms include plural forms unless the context indicates otherwise, and “comprises” or “comprising” specify the presence of stated elements but do not preclude additional elements. References to FIDO, FIDO2, and FIDO U2F herein are used for identification purposes only and refer to trademarks of the FIDO Alliance. References to WebAuthn refer to a service mark of the World Wide Web Consortium (W3C).

The present application builds upon and refines the biometric-authentication construct disclosed in the priority applications to which this application claims priority, including without limitation U.S. patent application Ser. No. 19/050,160 (the immediate parent application of the present application), U.S. patent application Ser. No. 18/782,801 (granted as U.S. Pat. No. 12,603,780), U.S. Pat. Nos. 12,072,963, and 11,582,032. For clarity of correspondence between the terminology used in the priority applications and the terminology used herein, the following mapping applies, and is incorporated into every embodiment described herein except where expressly indicated otherwise: (a) the “Secret-Key (S1)” of the priority applications corresponds to the “proprietary biometric key (PBK) (206)” described herein, the Secret-Key (S1)/proprietary biometric key (PBK) (206) being computed by an application processor (104) of a mobile device (100) by processing a biometric sample captured from the user; (b) the “Unique-Number (N1)” of the priority applications corresponds to the “document hash (DocHash) (216)” described herein, the present application disclosing as a refinement of the priority applications that the Unique-Number (N1) is implemented as a document hash (DocHash) (216) deterministically computed from canonicalized attribute fields of an identity-anchor record (110) in lieu of being generated by a random number generation algorithm, the deterministic property thereby providing additional technical advantages including Sybil resistance through deduplication at a relying party server (114) and cross-device credential recovery through deterministic regeneration of the Unique-Number (N1) on a replacement device; (c) the “Function (F1)” of the priority applications corresponds to the “key derivation function” described herein, the present application disclosing as one such embodiment HKDF-SHA256 as defined in RFC 5869, and otherwise encompassing any deterministic cryptographic construction operative to produce output keying material from the Secret-Key (S1) as input keying material and the Unique-Number (N1) as salt; (d) the “Public-Key (P1)” of the priority applications corresponds to the “credential wrapping key (CWK) (220)” described herein, the credential wrapping key (CWK) (220) being computed by the application processor (104) in transient volatile memory of the application's process as P1=F1(S1, N1), and being used by the application processor (104) to wrap a credential record referencing a credential private key (CPK) (222) held within a hardware security module (106) of the mobile device (100), with the private half of the credential private key (CPK) (222) being hardware-bound and non-extractable from the hardware security module (106) at all times; (e) the “Real-Time-Unique-Number (N2)” computation of the priority applications corresponds to the present application's re-derivation of the credential wrapping key (CWK) (220) in transient volatile memory of the application's process from a fresh proprietary biometric key (PBK) (206) (Secret-Key (S2)) and the retrieved document hash (DocHash) (216) (Unique-Number (N1)), and the present application's “successful unwrapping” of the stored wrapped credential record using the re-derived credential wrapping key (CWK) (220) corresponds to the “comparison of N2 with stored N1” of the priority applications, in that successful unwrapping demonstrates equivalence of the re-derived Public-Key (P1) with the originally-computed Public-Key (P1). Throughout the present specification, references to the proprietary biometric key (PBK) (206), the document hash (DocHash) (216), the credential wrapping key (CWK) (220), the key derivation function, and the re-derivation operations are to be understood as embodiments of, and refinements upon, the Secret-Key (S1), Unique-Number (N1), Public-Key (P1), Function (F1), and Real-Time-Unique-Number (N2) operations of the priority applications, respectively.

The aspects of the present invention are directed to a computer-implemented system and method for generating and managing a credential private key the use of which is bound to two independent cryptographic anchors: a proprietary biometric key computed in real-time by an application processor of a mobile device in transient volatile memory of an application's process without persisting any biometric template, and a deterministic document hash derived from canonicalized attribute fields of an identity-anchor record, wherein the credential private key itself is generated by and held within a hardware security module of the mobile device such that the private half of the credential private key is hardware-bound and non-extractable. The system simultaneously provides passwordless authentication via the FIDO2/WebAuthn standard, templateless biometric privacy, cross-device credential recovery using the identity-anchor record as a recovery vector, and Sybil resistance by leveraging the document hash as a deduplication anchor on a relying party server. The invention addresses technical limitations in existing FIDO2 implementations where credential keys lack an intrinsic link to user identity, where credential recovery depends on server-side key backup, and where biometric templates are persistently stored, creating privacy and security vulnerabilities.

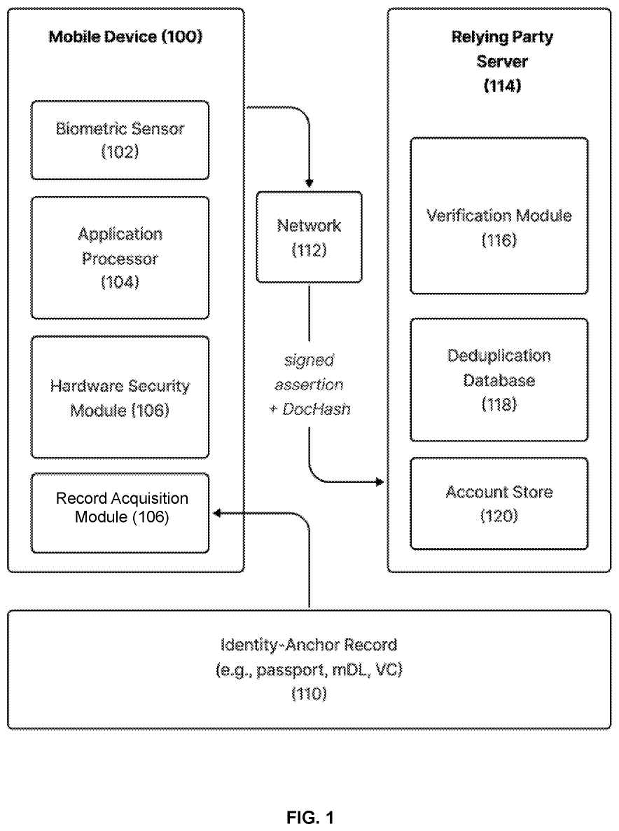

Referring now to FIG. 1, a system architecture for generating identity-anchored biometrics-based credential keys is illustrated, in accordance with an embodiment of the present subject matter. The system comprises a mobile device (100) communicatively coupled to a relying party server (114) via a network (112). The mobile device (100) comprises a biometric sensor (102), an application processor (104), a hardware security module (106), and an identity-anchor record acquisition module (108). The relying party server (114) comprises a credential verification module (116), a deduplication database (118), and an account store (120). In one embodiment, the mobile device (100) is configured to capture biometric samples from a user, extract attribute fields from an identity-anchor record (110), derive cryptographic key material, and transmit a signed attestation object and a computed document hash to the relying party server (114) for credential registration and identity deduplication.

In one embodiment, the mobile device (100) is an electronic computing device equipped with integrated biometric sensing, cryptographic processing, and document capture capabilities. The mobile device (100) may be a smartphone, a tablet computing device, or any portable electronic device that includes a hardware security module (106) and a biometric sensor (102). The mobile device (100) serves as the primary platform on which the credential private key is generated, stored, and used for signing WebAuthn attestation and assertion objects. The mobile device (100) is configured to interface with the hardware security module (106) such that the private half of the credential private key (CPK) (222) is generated within, held within, and used for ECDSA signature operations within an isolated execution environment of the hardware security module (106), thereby preventing exposure of the private half of the credential private key (CPK) (222) to potentially compromised application software or operating system components.

In one embodiment, the biometric sensor (102) is a hardware component integrated into or communicatively coupled to the mobile device (100) and is configured to capture a biometric sample from a user in real-time. The biometric sensor (102) may comprise one or more sensing modalities, including, without limitation, a front-facing camera, a fingerprint sensor, an iris recognition sensor, and a microphone or other audio capture device. The biometric sensor (102) transmits the captured biometric sample to the application processor (104) for further processing.

In one embodiment, the application processor (104) is a microprocessor, microcontroller, or system-on-chip configured to fetch and execute computer-readable instructions stored in a memory of the mobile device (100). The application processor (104) orchestrates the overall workflow of the system by coordinating biometric capture, identity-anchor record scanning, key derivation operations, and network communication. The application processor (104) is communicatively coupled to the biometric sensor (102), the hardware security module (106), the identity-anchor record acquisition module (108), and a network interface of the mobile device (100). The application processor (104) is configured to execute programmed instructions for initiating biometric capture, performing biometric feature extraction and proprietary biometric key (PBK) computation in transient volatile memory of the application's process, initiating identity-anchor record scanning via the identity-anchor record acquisition module (108), performing canonicalization and document hash (DocHash) computation in transient volatile memory of the application's process, deriving the credential wrapping key (CWK) in transient volatile memory of the application's process, coordinating with the hardware security module (106) to establish the credential private key (CPK) and to invoke ECDSA signing operations on supplied digests, and constructing and transmitting WebAuthn attestation and assertion objects to the relying party server (114) via the network (112). In one embodiment, the application processor (104) executes an application software layer that interfaces with the hardware security module (106) through platform-specific secure APIs.

In one embodiment, the hardware security module (106) is a dedicated, tamper-resistant key store integrated into the mobile device (100) and configured, via platform-exposed application programming interfaces, to (i) generate an asymmetric keypair such that the private half of the asymmetric keypair is hardware-bound and non-extractable, (ii) hold the private half within an isolated execution environment such that the private half cannot be exported from the hardware security module (106) in plaintext, and (iii) produce a digital signature over a digest supplied by the application processor (104) using the hardware-bound private half, conditioned on a successful biometric-authentication result reported by a platform biometric subsystem of the mobile device (100). The hardware security module (106) is operatively coupled to the application processor (104) via a platform-specific secure interface. In one embodiment, the hardware security module (106) is not configured to perform arbitrary computations on data supplied by the application processor (104); in particular, in such embodiment the hardware security module (106) is not configured to process biometric samples, to perform a key derivation function over application-supplied input key material and salt, or to perform a key-wrap or key-unwrap operation using an externally-supplied key encryption key, and operations of that character are performed by the application processor (104) in transient volatile memory of the application's process as further described herein. In one embodiment, the hardware security module (106) is an Apple Secure Enclave accessed via the Security framework on iOS. In another embodiment, the hardware security module (106) is an Android StrongBox Keystore (706) accessed via the Android Keystore API. In yet another embodiment, the hardware security module (106) is an Android Trusted Execution Environment (TEE) (708) used as a fallback for devices without dedicated StrongBox hardware. The hardware security module (106) ensures that the private half of the credential private key (CPK) (222) is not exposed to the operating system of the mobile device (100) or to application software of the mobile device (100) in plaintext form.

In one embodiment, the identity-anchor record acquisition module (108) is a hardware component or a combination of hardware and software configured to acquire an identity-anchor record (110) and to parse attribute fields from the identity-anchor record (110). The identity-anchor record acquisition module (108) is configured to obtain the identity-anchor record (110) by any of: (a) reading from an embedded near-field communication (NFC) chip in an ICAO-9303-compliant travel document such as a passport or a national identity card, with cryptographic verification of the extracted attribute fields against a digital signature stored on the NFC chip; (b) receiving the identity-anchor record via Bluetooth Low Energy (BLE) or another short-range wireless protocol in accordance with ISO/IEC 18013-5 (mobile driver's license); (c) ingestion from an application programming interface (API) endpoint of an issuing authority or a delegated identity provider; (d) wallet-to-wallet credential exchange in accordance with a credential-handler protocol such as CHAPI, OpenID for Verifiable Credential Issuance (OpenID4VCI), or OpenID for Verifiable Presentations (OpenID4VP); (e) decoding of a QR-code-encoded signed credential; (f) parsing of a digital identity-anchor record serialized in JSON-LD, JSON Web Token (JWT), CBOR, or a similar serialization, with cryptographic verification of the extracted attribute fields against a digital signature of an issuer of the identity-anchor record; or (g) any other method of obtaining a cryptographically-authenticated identity-anchor record from a trusted issuer. The identity-anchor record acquisition module (108) extracts attribute fields from the identity-anchor record (110) and transmits the extracted attribute fields to the application processor (104) for canonicalization and hashing. In each of the foregoing embodiments, the identity-anchor record acquisition module (108) is configured to cryptographically verify the identity-anchor record (110) against a digital signature of an issuer of the identity-anchor record (110) using a public key or a certificate chain of the issuer, and to abort the credential creation ceremony when the cryptographic verification fails, prior to forwarding the extracted attribute fields to the application processor (104) for canonicalization and hashing.

In one embodiment, the identity-anchor record (110) is a tangible or digital record presented by the user during credential creation or cross-device recovery. As used herein and in the appended claims, the term “identity-anchor record” refers to a record that (i) attests to or contains one or more attributes of an individual, (ii) is issued, signed, or otherwise authenticated by a trusted issuer or by means of a cryptographic anti-counterfeiting mechanism, and (iii) when canonicalized in accordance with a canonicalization procedure as described herein, deterministically distinguishes the individual from other individuals within a relevant population. The identity-anchor record (110) is selected from a non-exhaustive group consisting of: a government-issued passport compliant with the ICAO 9303 standard, wherein the attribute fields are extractable from an embedded NFC chip and are cryptographically verifiable against a digital signature of the NFC chip; a government-issued driver's license; a government-issued national identity card; a mobile driver's license compliant with ISO/IEC 18013-5; a verifiable credential in W3C Verifiable Credentials format, wherein the attribute fields are extractable from a JSON-LD or JSON Web Token serialization of the verifiable credential and are cryptographically verifiable against a digital signature of an issuer of the verifiable credential; a decentralized identifier (DID) bound to one or more verifiable credentials; a credential issued under an eIDAS digital identity wallet framework; a professional license issued by a recognized authority; an educational credential, including a credential compliant with the Blockcerts or EBSI standards; an employer-issued credential containing attribute fields authenticated by an employer; and any other tangible or digital record containing attribute fields that are authenticated by a trusted source and that, in combination, deterministically distinguish the individual. The identity-anchor record (110) contains immutable or stable attribute fields that, when canonicalized and hashed, produce a deterministic document hash (DocHash) (216) that remains identical across different extraction sessions, different devices, and different time periods, provided the same identity-anchor record is presented. The attribute fields are never stored on the mobile device (100) or transmitted to the relying party server (114); only the cryptographic digest of the canonicalized attribute fields is persisted or transmitted.

In one embodiment, the network (112) is a communication network that communicatively couples the mobile device (100) to the relying party server (114). The network (112) may be a cellular communication network, the Internet, a local area network (LAN), a wide area network (WAN), or any combination thereof. In one embodiment, the network (112) may support communication over protocols including HTTP, HTTPS, TCP/IP, and may employ security mechanisms such as Transport Layer Security (TLS) and Secure Sockets Layer (SSL) encryption to protect data in transit between the mobile device (100) and the relying party server (114). In some embodiments, the network (112) supports wireless communication over one or more types of networks including a mobile telephone network (such as CDMA, GSM, WCDMA, UMTS, 3G, 4G, or 5G), a wireless local area network (WLAN) in accordance with IEEE 802.11 standards, or a satellite network. The secure communication channel established via the network (112) ensures that the attestation objects, assertion objects, and document hash values transmitted between the mobile device (100) and the relying party server (114) are protected against interception, tampering, and replay attacks.

In one embodiment, the relying party server (114) is a computing server operated by a service provider and configured to manage FIDO2 credential registrations, authenticate users via WebAuthn assertion verification, enforce Sybil resistance through document hash deduplication, and facilitate cross-device credential recovery. The relying party server (114) is communicatively coupled to the mobile device (100) via the network (112). The relying party server (114) comprises at least one processor and a memory, and is configured to execute programmed instructions for receiving and verifying WebAuthn attestation and assertion objects, storing credential public keys and document hashes, and performing deduplication checks. The relying party server (114) does not store the credential private key (CPK) (222), biometric data, or identity-anchor record attribute fields; it stores only the cryptographic digest of the canonicalized attribute fields (the document hash (DocHash) (216)) and the credential public key corresponding to the credential private key (CPK) (222).

In one embodiment, the credential verification module (116) is a software module stored in the memory of the relying party server (114) and executable by the processor of the relying party server (114). The credential verification module (116) is configured to verify attestation objects received during credential registration ceremonies and to verify authentication assertions received during authentication ceremonies. The credential verification module (116) performs cryptographic signature verification using the stored credential public key to confirm that the assertion was signed by the corresponding credential private key (CPK) (222). The credential verification module (116) is further configured to verify that the challenge value in the attestation or assertion matches the challenge issued by the relying party server (114), that the origin matches the expected relying party identifier, and that user presence and user verification flags are appropriately set. Upon successful verification, the credential verification module (116) signals the relying party server (114) to grant access to the authenticated user. In a preferred embodiment, the credential verification module (116) is implemented as a WebAuthn verification module compliant with the W3C WebAuthn specification, the attestation objects are WebAuthn attestation objects, and the authentication assertions are WebAuthn assertion objects; in alternative embodiments, the credential verification module (116) is implemented in accordance with any other passkey or asymmetric-credential verification protocol that produces a verifiable signature over a server-issued challenge.

In one embodiment, the deduplication database (118) is a persistent data storage structure maintained by the relying party server (114) and configured to store document hash (DocHash) (216) entries indexed by their hash values and linked to corresponding user identifiers in the account store (120). The deduplication database (118) is configured to enforce a one-person-one-account constraint by enabling the relying party server (114) to check whether a given document hash (DocHash) (216) already exists in the database upon each credential registration attempt. In some embodiments, the deduplication database (118) is implemented as a hash table or B-tree indexed by the document hash (DocHash) (216), with collision handling mechanisms for documents that produce the same hash value. The deduplication database (118) stores only the cryptographic hash value, not the underlying attribute fields, thereby preserving user privacy while enabling Sybil resistance. The deduplication database (118) cannot be reversed to recover the name, date of birth, or other personal information of the user, assuming the hash function employed is cryptographically secure and the attribute fields are sufficiently entropic.

In one embodiment, the account store (120) is a persistent data storage structure maintained by the relying party server (114) and configured to store credential public keys, user identifiers, user handles, and sign count values associated with registered FIDO2 credentials. The account store (120) is indexed by user identifier and is linked to corresponding entries in the deduplication database (118) via the document hash (DocHash) (216). The account store (120) is configured to maintain a sign count per credential, wherein the sign count is incremented upon each successful authentication ceremony. The relying party server (114) is configured to compare a received sign count in an assertion with the stored sign count in the account store (120) and to reject an assertion when the received sign count is not incremented relative to the stored sign count, thereby preventing replay attacks from cloned credentials. For example, if the stored sign count is 15 and the relying party server (114) receives an assertion with sign count 16, the assertion is accepted and the stored count is updated to 16; however, if a cloned credential subsequently transmits an assertion with sign count 14 or 15, the assertion is rejected because the sign count has not incremented beyond the stored value.

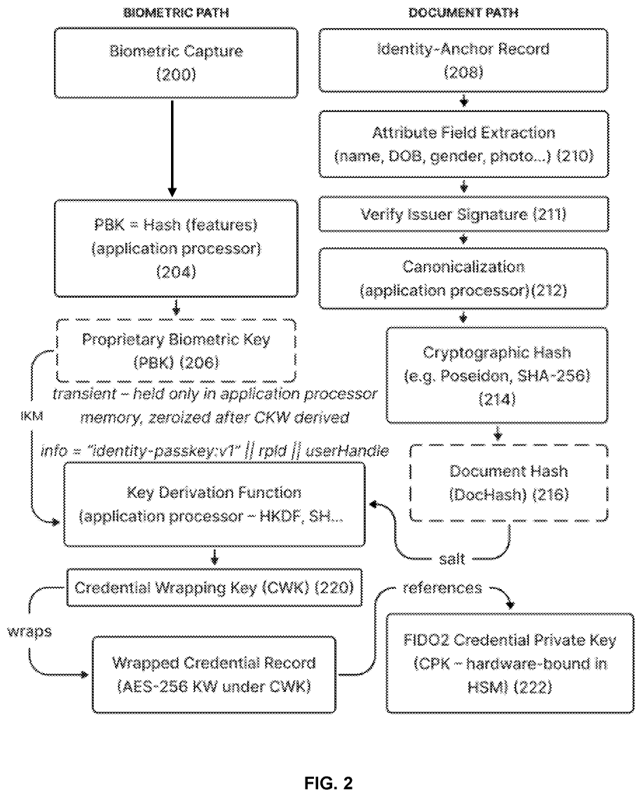

Overall, the system architecture illustrated in FIG. 1 provides a comprehensive infrastructure for generating credential private keys that are intrinsically anchored to both the user's biometric identity and their verified identity-anchor record, while maintaining strict separation between the mobile device (100) and the relying party server (114) such that sensitive key material and biometric data never leave the mobile device (100). The specific details of the key derivation pipeline, the credential creation ceremony, the authentication ceremony, the cross-device recovery flow, and the deduplication mechanism are further elaborated in the descriptions of FIGS. 2 through 7, respectively.

Referring now to FIG. 2, a key derivation pipeline for generating the credential private key (CPK) (222) from biometric and identity-anchor record inputs is illustrated, in accordance with an embodiment of the present subject matter. FIG. 2 depicts a hierarchical key derivation architecture comprising two parallel input paths, a biometric path and a document path, that converge in a combined derivation stage to produce the credential wrapping key (CWK) (220) and to bind the credential private key (CPK) (222) thereto. The key derivation pipeline is executed by the application processor (104) in transient volatile memory of the application's process, such that intermediate cryptographic values produced by the key derivation pipeline, including the proprietary biometric key (PBK) (206) and the credential wrapping key (CWK) (220), are retained only in transient volatile memory of the application's process and are zeroized immediately after use; and the credential private key (CPK) (222) produced at the output of the key derivation pipeline is generated within, held within, and used for ECDSA signature operations within the hardware security module (106) such that the private half of the credential private key (CPK) (222) is hardware-bound and non-extractable, as further described herein.

In one embodiment, the biometric path of the key derivation pipeline comprises a biometric capture step (200) wherein the biometric sensor (102) of the mobile device (100) captures a biometric sample from the user in real-time, and a real-time key computation step (204) wherein the captured biometric sample is processed by the application processor (104) in transient volatile memory of the application's process to compute a proprietary biometric key (PBK) (206) corresponding to the user. The biometric sample is processed transiently in the application processor (104) and is not persisted to non-volatile storage.

In one embodiment, the computed proprietary biometric key (PBK) (206) is retained only in transient volatile memory of the application's process, is zeroized immediately after derivation therefrom of the credential wrapping key (CWK) (220), and is never persisted to non-volatile storage, disk, or any server.

In one embodiment, the document path of the key derivation pipeline begins with the identity-anchor record (208), which corresponds to the identity-anchor record (110) described with reference to FIG. 1. The identity-anchor record (208) is presented to the identity-anchor record acquisition module (108) of the mobile device (100). A field extraction step (210) extracts attribute fields from the identity-anchor record (208), the attribute fields comprising one or more attributes selected from the group consisting of: a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record, wherein the attribute fields are selected such that, in combination, they deterministically distinguish the individual from other individuals within a relevant population. In other embodiments, the attribute fields are extracted from an embedded NFC chip in an ICAO 9303-compliant travel document and are cryptographically verified against the chip's digital signature to prevent forgery. In further embodiments, the attribute fields are extracted from a digital identity-anchor record by parsing a JSON-LD, JSON Web Token, CBOR, or similar serialization of the identity-anchor record and cryptographically verifying the attribute fields against a digital signature of an issuer of the identity-anchor record. A signature verification step (211) cryptographically verifies the identity-anchor record (208) against a digital signature of an issuer of the identity-anchor record using a public key or certificate chain of the issuer, and aborts the credential creation ceremony if the verification fails.

In one embodiment, the extracted attribute fields are forwarded to a canonicalization step (212). The canonicalization step (212) transforms the extracted attribute fields into a standardized, deterministic representation by application of a canonicalization procedure adapted to a serialization format of the identity-anchor record, the canonicalization procedure comprising one or more operations selected from normalizing whitespace, handling diacritics, applying uniform case conversion, JSON-LD canonicalization in accordance with URDNA2015, CBOR-deterministic encoding in accordance with RFC 8949 Section 4.2.1, and a combination of the foregoing. The canonicalization step (212) further constructs a canonical byte representation by concatenating the canonicalized attribute fields and, where the identity-anchor record contains a photograph, biometric reference, or other binary attachment, a cryptographic hash of the bytes of the photograph, biometric reference, or binary attachment, using a cryptographic hash function. In one embodiment, where the identity-anchor record is a government-issued identity document containing at least a full legal name, a date of birth, a gender, and a photograph, the canonical byte representation is constructed as: canonical_bytes=canonical_name∥DOB∥gender∥Hash(photo_bytes), where ∥ denotes byte concatenation and Hash(photo_bytes) is a cryptographic hash, such as SHA-256, of the raw photograph bytes. In another embodiment, where the identity-anchor record is a verifiable credential in W3C Verifiable Credentials format, the canonical byte representation is constructed by serializing the verifiable credential under a JSON-LD canonicalization scheme such as URDNA2015 and applying the cryptographic hash function to the canonicalized serialization. In yet another embodiment, where the identity-anchor record is a decentralized identifier (DID) bound to one or more verifiable credentials, the canonical byte representation is constructed by canonicalizing each bound verifiable credential and concatenating the resulting canonicalized serializations with a domain separator. In each embodiment, the canonical byte representation is selected such that the same identity-anchor record produces an identical canonical byte representation across different extraction sessions, different devices, and different time periods. For example, if a passport contains the name “Jose Maria GARCIA”, the canonicalization step (212) normalizes the diacritics and applies lowercase conversion to produce “jose maria garcia”, strips any extra whitespace, and constructs the canonical byte representation as: “jose maria garcia”∥“1985 Mar. 15”∥“M”∥SHA-256(photo_bytes), where ∥ denotes byte concatenation. The canonicalization step (212) ensures that the same identity-anchor record will always produce the same canonical byte representation, regardless of minor variations in how the record is scanned or extracted.

In one embodiment, the canonical byte representation produced by the canonicalization step (212) is forwarded to a zero-knowledge-friendly hash step (214). The zero-knowledge-friendly hash step (214) computes a document hash (DocHash) (216) by applying a zero-knowledge-friendly cryptographic hash function to the canonical byte representation with a domain separator. In the preferred embodiment, the zero-knowledge-friendly hash function is the Poseidon hash function, and the document hash (DocHash) (216) is computed as: DocHash=Poseidon(canonical_bytes, ‘identity:dedup:v1’). The second parameter is a domain separator string that prevents hash collisions across different protocol versions or applications. In alternative embodiments, other zero-knowledge-friendly hash functions such as Pedersen, Mimc, or Poseidon variants may be used. In yet other embodiments, classical cryptographic hash functions such as SHA-256, SHA-3, or BLAKE2 may be employed when zero-knowledge proof compatibility is not required. The computed document hash (DocHash) (216) is deterministic such that a same identity-anchor record produces a same document hash (DocHash) (216) across different devices, different extraction sessions, and different time periods.

In one embodiment, the document hash (DocHash) (216) serves a dual purpose in the system. First, the document hash (DocHash) (216) acts as a salt in the key derivation function used to derive the credential wrapping key (CWK) (220), making the derived credential key deterministic for the given user and identity-anchor record combination. Second, the document hash (DocHash) (216) simultaneously serves as a Sybil-resistance deduplication anchor on the relying party server (114), enabling the relying party server (114) to detect and prevent multiple account registrations by the same individual. This dual-purpose construction is a key technical innovation of the present invention, as it eliminates the need for separate identity verification and deduplication flows that characterize existing approaches.

In one embodiment, the proprietary biometric key (PBK) (206) from the biometric path and the document hash (DocHash) (216) from the document path converge in a combined derivation stage. An HKDF step (218), executed by the application processor (104) in transient volatile memory of the application's process, derives a credential wrapping key (CWK) (220) by applying a key derivation function with the computed proprietary biometric key (PBK) (206) as input key material (IKM), the computed document hash (DocHash) (216) as salt, and context information comprising a relying party identifier (rpId) and a user handle as an info parameter, wherein the derived credential wrapping key (CWK) (220) is retained only in transient volatile memory of the application's process and is zeroized immediately after use. In the preferred embodiment, the key derivation function is HKDF-SHA256 as defined in RFC 5869, and the credential wrapping key (CWK) (220) is computed as: CWK=HKDF-SHA256(ikm=PBK, salt=DocHash, info=‘identity-passkey:v1’∥rpId∥userHandle, L=32), where L is the desired output length of 32 bytes (256 bits). The info parameter comprises a protocol version string (‘identity-passkey:v1’) concatenated with the relying party identifier and the user handle, providing domain separation across different relying parties and different user accounts within the same relying party. For example, when the relying party identifier is “login.example.com” and the user handle is “user_abc123”, the HKDF-SHA256 computation produces a 256-bit credential wrapping key (CWK) (220) as: CWK=HKDF-SHA256(ikm=PBK, salt=DocHash, info=“identity-passkey:v1∥login.example.com∥user_abc123”, L=32). This ensures that the same user registered with a different relying party, for instance “banking.example.org”, would derive a completely different credential wrapping key, providing cryptographic domain separation between relying parties. In alternative embodiments, other key derivation functions such as HKDF with SHA-3 or BLAKE2, Argon2, or Scrypt may be used. As used herein and in the appended claims, the term “key derivation function” is to be construed broadly to encompass any deterministic cryptographic construction operative to produce output keying material from one or more inputs comprising input keying material, optional salt, and optional context information, including without limitation extract-then-expand constructions, hash-based key derivation constructions employing a domain separator, pseudorandom-function-based constructions, and password-derived or memory-hard key derivation constructions.

In one embodiment, the credential wrapping key (CWK) (220) is unique to the combination of the user's biometric characteristics (via the proprietary biometric key (PBK) (206)), their identity-anchor record (via the document hash (DocHash) (216)), and the specific relying party (via the rpId in the info parameter). This construction ensures that the same user will have different credential wrapping keys for different relying parties, providing cryptographic isolation between relying party domains. Furthermore, a user's document hash (DocHash) (216) remains constant across devices, enabling the deterministic component of cross-device credential recovery, while the proprietary biometric key (PBK) (206) component ensures that only the legitimate user, as verified by a live biometric sample, can derive the credential wrapping key (CWK) (220).

In one embodiment, the credential private key (CPK) (222) is generated by the hardware security module (106) such that the private half of the credential private key (CPK) (222) is hardware-bound, non-extractable, and never leaves the hardware security module (106) in plaintext, and use of the credential private key (CPK) (222) is bound to a combination of the computed proprietary biometric key (PBK) (206), the computed document hash (DocHash) (216), and the relying party identifier by means of the derived credential wrapping key (CWK) (220), as described with reference to paragraph 51. The credential private key (CPK) (222) is the cryptographic key used to generate attestation and assertion signatures in credential-registration and authentication ceremonies. The credential public key is computed from the credential private key (CPK) (222) at the time of keypair generation by the hardware security module (106) and is exported by the hardware security module (106) to the application processor (104), and is embedded in the attestation object for transmission to the relying party server (114). In a preferred embodiment, the credential private key (CPK) (222) is a credential private key compliant with the WebAuthn specification of the World Wide Web Consortium (W3C) and the FIDO2 specification of the FIDO Alliance, the attestation object signed at credential creation is a WebAuthn attestation object, the authentication assertion produced during authentication is a WebAuthn assertion object, and the credential private key (CPK) (222) is an ECDSA P-256 keypair with signature algorithm ES256 as defined in COSE RFC 8152; in alternative embodiments, the credential private key (CPK) (222) is any asymmetric authentication credential whose private half is hardware-bound and non-extractable within the hardware security module (106) and whose signature operations are invoked via a platform-mediated, biometric-gated authorization, and the attestation object and authentication assertion are formatted in accordance with the corresponding credential protocol.

In one embodiment, the credential private key (CPK) (222) is associated with the derived credential wrapping key (CWK) (220) by a wrapping method, in which the hardware security module (106) generates the credential private key (CPK) (222) internally such that the private half of the credential private key (CPK) (222) is hardware-bound, non-extractable, and never leaves the hardware security module (106) in plaintext, and the hardware security module (106) returns to the application processor (104) a platform-specific credential identifier comprising at least a key handle, alias, or reference by which the application processor (104) may subsequently invoke the hardware security module (106) to perform an ECDSA signature operation using the credential private key (CPK) (222). The application processor (104) constructs, in transient volatile memory of the application's process, a credential record comprising the credential identifier returned by the hardware security module (106) and binding metadata identifying the relying party identifier and the user handle, and the application processor (104) wraps the credential record using the credential wrapping key (CWK) (220) as a key encryption key by application of a key wrapping algorithm or an authenticated-encryption-with-associated-data algorithm, to produce a wrapped credential record. In the preferred embodiment, the key wrapping algorithm is AES-256-Key Wrap as defined in RFC 3394; in alternative embodiments, the algorithm is selected from AES Key Wrap with Padding as defined in RFC 5649, AES-256-GCM, AES-256-SIV, AES-256-CCM, ChaCha20-Poly1305, or another authenticated-encryption-with-associated-data construction. The wrapped credential record is stored in encrypted form in non-volatile storage of the mobile device (100). The plaintext credential record and the credential wrapping key (CWK) (220) are zeroized from transient volatile memory of the application's process immediately after wrapping. During a subsequent authentication ceremony, the application processor (104) re-derives the credential wrapping key (CWK) (220) in transient volatile memory of the application's process from a fresh proprietary biometric key (PBK) (206) and the stored document hash (DocHash) (216) and unwraps the stored wrapped credential record, recovering the credential identifier; the application processor (104) then invokes the hardware security module (106) to produce an ECDSA signature using the credential private key (CPK) (222) referenced by the credential identifier. The wrapping method is the preferred embodiment for cross-platform deployments and is supported on all platforms whose hardware security module (106) is capable of internal asymmetric keypair generation with a hardware-bound non-extractable private half and platform-mediated biometric-gated ECDSA signing, including the Apple Secure Enclave on iOS, the Android StrongBox Keystore (706), and the Android Trusted Execution Environment (TEE) (708). For example, during a credential creation ceremony on iOS, the hardware security module (106) generates a hardware-bound ECDSA P-256 keypair via the Security framework's key-generation primitive with the kSecAttrTokenIDSecureEnclave attribute set, and returns to the application processor (104) a credential identifier such as a key reference together with an application tag stored in the keychain; the application processor (104) constructs a credential record CR=(credential_identifier∥rpId∥userHandle), wraps it as WrappedCR=AES-256-KeyWrap(CWK, CR), zeroizes CWK and the plaintext CR from transient volatile memory of the application's process, and stores the WrappedCR in non-volatile storage; during a subsequent authentication ceremony, the application processor (104) re-derives CWK from a fresh PBK and the stored DocHash, recovers CR=AES-256-KeyUnwrap(CWK, WrappedCR), parses out the credential identifier, and submits a digest of the WebAuthn client data and authenticator data to the hardware security module (106) for ECDSA signature using the credential private key (CPK) (222) referenced by the credential identifier, conditioned on platform-mediated biometric authorization. The private half of the credential private key (CPK) (222) remains hardware-bound within the hardware security module (106) throughout both ceremonies. In an alternative embodiment, the credential private key (CPK) (222) is associated with the derived credential wrapping key (CWK) (220) by a deterministic-derivation method, in which the application processor (104) hashes the credential wrapping key (CWK) (220) in transient volatile memory of the application's process and interprets the resulting bytes as a scalar in a field of the ECDSA P-256 curve in a valid range of [1, n−1], where n is the order of the P-256 curve, and the application processor (104) imports the resulting scalar into the hardware security module (106) as the credential private key (CPK) (222) by way of a platform key-import application programming interface, on platforms supporting hardware-backed import of an externally-supplied private key such that, following import, the private half of the credential private key (CPK) (222) is hardware-bound and non-extractable from the hardware security module (106). The scalar is zeroized from transient volatile memory of the application's process immediately after import. The deterministic-derivation embodiment is available on platforms whose hardware security module (106) supports hardware-backed key import, such as Android Keystore on configurations permitting key import. On platforms whose hardware security module (106) does not support hardware-backed key import of an externally-supplied EC private key, including the Apple Secure Enclave, the deterministic-derivation embodiment is not available and the wrapping embodiment described above is used instead.

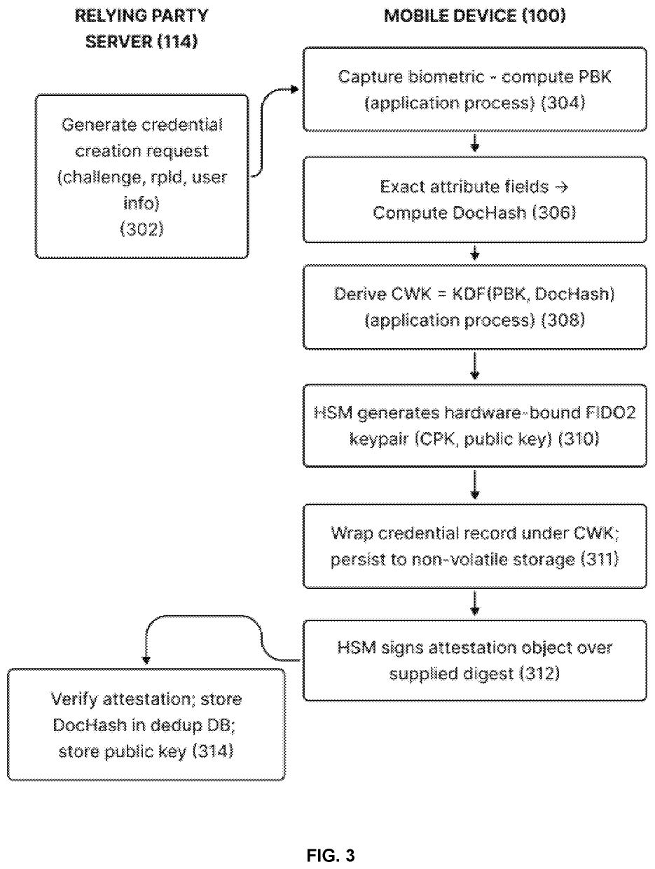

In some embodiments, alternative elliptic curve cryptography (ECC) algorithms are used for the credential private key (CPK) (222). These alternatives include ECDSA with P-384 or P-521 curves for higher security margins, EdDSA with Ed25519 or Ed448 curves for improved performance characteristics, or post-quantum cryptographic algorithms such as Dilithium or Falcon for resistance against quantum computing attacks. The selection of the specific signature algorithm is determined by the capabilities of the hardware security module (106) and the requirements of the relying party server (114). The specific details of the credential creation ceremony, wherein the key derivation pipeline of FIG. 2 is invoked to generate a new FIDO2 credential and transmit it to the relying party server (114), are further elaborated in the description of FIG. 3.

Referring now to FIG. 3, a credential creation ceremony for registering a FIDO2 credential with identity-anchor-record-composed anchoring is illustrated, in accordance with an embodiment of the present subject matter. The credential creation ceremony corresponds to the WebAuthn navigator.credentials.create( ) flow and depicts the sequential steps performed by the relying party server (114) and the mobile device (100) to generate and register a new FIDO2 credential. The method comprises steps of receiving a credential creation request, capturing biometric data and extracting attribute fields from an identity-anchor record, deriving key material through the pipeline of FIG. 2, generating the credential private key (CPK) (222), creating a signed attestation object, and transmitting the attestation object and document hash to the relying party server (114) for verification and storage.

At step (302), the relying party server (114) initiates the credential creation ceremony by generating a credential creation request comprising a challenge, a relying party identifier (rpId), and user information including a user name and a user display name. The challenge is a cryptographically random value, in one embodiment a 32-byte random value, generated by the relying party server (114) to prevent replay attacks. The relying party identifier uniquely identifies the relying party within the WebAuthn protocol. The credential creation request is transmitted to the mobile device (100) via the network (112). For example, when a user registers with a web application at “login.example.com”, the relying party server (114) generates a 32-byte random challenge (such as 0x3f8c2e5a . . . 9b1d7f4c) and transmits it along with the relying party identifier “login.example.com” and the user's display name to the mobile device (100) via a secure HTTPS connection. The mobile device (100) receives the credential creation request and initiates the biometric capture and identity-anchor record extraction procedures.

At step (304), the mobile device (100) captures a biometric sample from the user in real-time using the biometric sensor (102). The application processor (104) processes the captured biometric sample in transient volatile memory of the application's process to compute a proprietary biometric key (PBK) (206), as described with reference to the biometric path of FIG. 2. The biometric sample is processed transiently in transient volatile memory of the application's process and is not persisted to non-volatile storage. The computed proprietary biometric key (PBK) (206) is retained only in transient volatile memory of the application's process and is zeroized immediately after derivation therefrom of the credential wrapping key (CWK) (220).

At step (306), the mobile device (100) extracts, via the identity-anchor record acquisition module (108), attribute fields from an identity-anchor record (110). The application processor (104) canonicalizes the extracted attribute fields by application of a canonicalization procedure adapted to a serialization format of the identity-anchor record, as described with reference to the canonicalization step (212) of FIG. 2. The application processor (104) then computes a document hash (DocHash) (216) by applying the zero-knowledge-friendly cryptographic hash function to the canonical byte representation with a domain separator, as described with reference to the zero-knowledge-friendly hash step (214) of FIG. 2. The computed document hash (DocHash) (216) is deterministic such that a same identity-anchor record produces a same document hash (DocHash) (216). The attribute fields are not stored on the mobile device (100) or transmitted to the relying party server (114).

At step (308), the application processor (104) derives a credential wrapping key (CWK) (220) in transient volatile memory of the application's process by applying the key derivation function with the computed proprietary biometric key (PBK) (206) as input key material, the computed document hash (DocHash) (216) as salt, and context information comprising the relying party identifier and a user handle as the info parameter, as described with reference to the HKDF step (218) of FIG. 2. The credential wrapping key (CWK) (220) is unique to the combination of the user's biometric identity, the user's identity-anchor record, and the specific relying party, and is retained only in transient volatile memory of the application's process pending its use in step (310).

At step (310), the credential private key (CPK) (222) is established such that the private half of the credential private key (CPK) (222) is hardware-bound and non-extractable within the hardware security module (106), and use of the credential private key (CPK) (222) is bound to the derived credential wrapping key (CWK) (220), in accordance with the preferred wrapping embodiment described with reference to paragraph 51 or, on platforms supporting hardware-backed key import, the alternative deterministic-derivation embodiment. In the preferred embodiment employing the wrapping method, the hardware security module (106) generates a hardware-bound ECDSA P-256 keypair internally and returns a credential identifier to the application processor (104), and the application processor (104) constructs a credential record comprising at least the credential identifier and binding metadata in transient volatile memory of the application's process, wraps the credential record using the credential wrapping key (CWK) (220) as a key encryption key by application of a key wrapping algorithm or authenticated-encryption-with-associated-data algorithm (such as AES-256-Key Wrap as defined in RFC 3394), and stores the wrapped credential record in non-volatile storage of the mobile device (100). In the alternative embodiment employing the deterministic-derivation method, the application processor (104) hashes the credential wrapping key (CWK) (220) in transient volatile memory of the application's process, interprets the resulting bytes as a scalar value on the ECDSA P-256 curve in a valid range of [1, n−1], and imports the scalar into the hardware security module (106) as the credential private key (CPK) (222) via a platform key-import application programming interface, after which the scalar is zeroized from transient volatile memory of the application's process. In both embodiments, the hardware security module (106) computes the corresponding credential public key from the credential private key (CPK) (222) using ECDSA P-256 public key derivation and exports the credential public key to the application processor (104).

At step (312), the application processor (104), in cooperation with the hardware security module (106), creates an attestation object. The attestation object comprises authenticator data including the credential public key derived from the credential private key (CPK) (222), a sign count initialized to zero, user presence and user verification flags, and the relying party identifier hash. The application processor (104) submits to the hardware security module (106) a digest of the attestation object, and the hardware security module (106) signs the digest using the credential private key (CPK) (222), producing an attestation statement that cryptographically binds the credential public key to the challenge issued by the relying party server (114), conditioned on a successful biometric-authentication result reported by the platform biometric subsystem of the mobile device (100). In the preferred embodiment, the attestation type is self-attestation, meaning the attestation statement is signed by the credential private key itself. The document hash (DocHash) (216) is stored in encrypted form in the non-volatile storage of the mobile device (100) for subsequent use during authentication ceremonies.

At step (314), the relying party server (114) receives the signed attestation object and the computed document hash (DocHash) (216) from the mobile device (100) via the network (112). The credential verification module (116) of the relying party server (114) verifies the signed attestation object by validating the signature over the challenge, confirming the origin, and checking the attestation statement. Upon successful verification, the relying party server (114) stores the computed document hash (DocHash) (216) in the deduplication database (118) and the credential public key in the account store (120). The relying party server (114) also initializes a sign count for the newly registered credential in the account store (120).

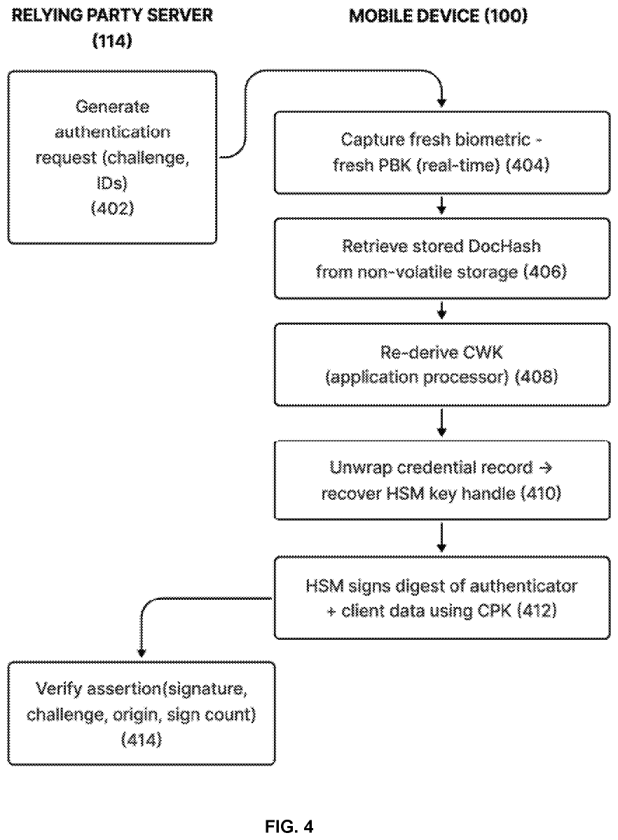

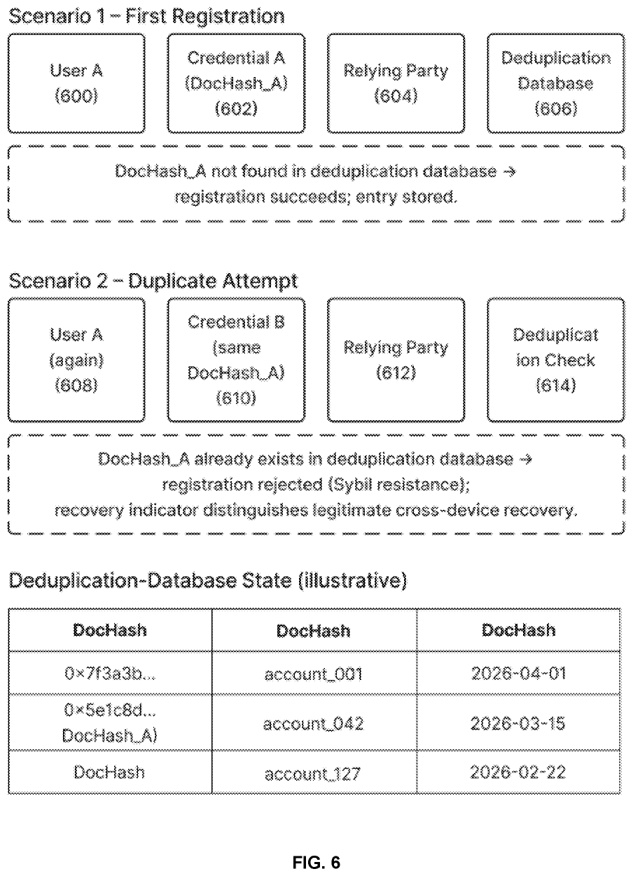

In one embodiment, prior to storing the document hash (DocHash) (216) in the deduplication database (118) at step (314), the relying party server (114) checks the deduplication database (118) to determine whether the computed document hash (DocHash) (216) matches an existing entry in the deduplication database (118). If a match is found, the relying party server (114) rejects the credential registration attempt, thereby preventing a single individual from registering multiple accounts with the relying party using the same identity-anchor record. If no match is found, the relying party server (114) proceeds with storing the document hash (DocHash) (216) and the credential public key, completing the credential registration. The deduplication check at step (314) enforces the one-person-one-account constraint that provides Sybil resistance. The specific details of how the deduplication mechanism operates in different scenarios are further elaborated in the description of FIG. 6. The authentication ceremony, wherein the registered credential is used for subsequent user authentication, is further elaborated in the description of FIG. 4.

Referring now to FIG. 4, an authentication ceremony for authenticating a user using the registered FIDO2 credential with identity-anchor-record-composed anchoring is illustrated, in accordance with an embodiment of the present subject matter. The authentication ceremony corresponds to the WebAuthn navigator.credentials.get( ) flow and depicts the sequential steps performed by the relying party server (114) and the mobile device (100) to authenticate a previously registered user. In one embodiment, the application processor (104) is configured to perform the authentication ceremony upon receiving a challenge from the relying party server (114).

At step (402), the relying party server (114) initiates the authentication ceremony by transmitting a challenge and credential identifiers to the mobile device (100) via the network (112). The challenge is a fresh cryptographically random value generated by the relying party server (114) to prevent replay attacks. The credential identifiers identify one or more registered credentials associated with the user's account. For example, when the user opens a banking application and requests account access, the relying party server (114) generates a fresh 32-byte random challenge and transmits it along with the credential identifier associated with the user's account. The mobile device (100) receives the challenge and credential identifiers and initiates the biometric capture procedure.

At step (404), the mobile device (100) captures a biometric sample from the user in real-time using the biometric sensor (102) to derive a fresh proprietary biometric key (PBK) (206). The proprietary biometric key (PBK) (206) is computed by the application processor (104) in transient volatile memory of the application's process by processing the captured biometric sample. The computed proprietary biometric key (PBK) (206) is retained only in transient volatile memory of the application's process and is zeroized immediately after derivation therefrom of the credential wrapping key (CWK) (220).

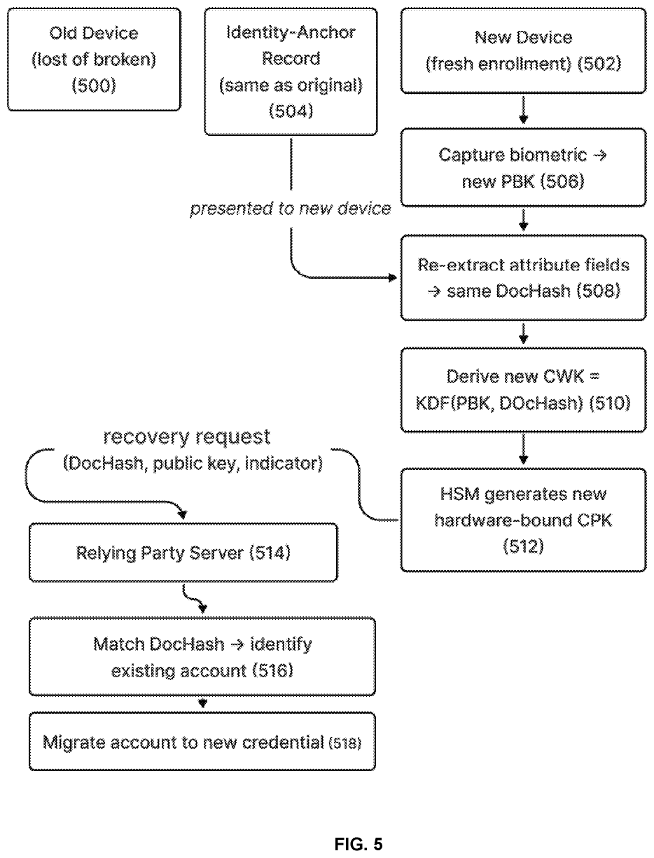

At step (406), the application processor (104) retrieves the stored document hash (DocHash) (216) from a secure storage of the mobile device (100). The document hash (DocHash) (216) was stored in encrypted form during the credential creation ceremony (step 312 of FIG. 3). The retrieval of the stored document hash (DocHash) (216) avoids the need for the user to represent their identity-anchor record during each authentication ceremony, thereby providing a practical and convenient authentication experience for frequent authentication sessions. In alternative embodiments, the document hash (DocHash) (216) may be re-derived by re-extracting attribute fields from the user's identity-anchor record, but this approach is typically reserved for the cross-device recovery flow described with reference to FIG. 5.

At step (408), the application processor (104) re-derives the credential wrapping key (CWK) (220) in transient volatile memory of the application's process by applying the key derivation function with the fresh proprietary biometric key (PBK) (206) as input key material and the retrieved document hash (DocHash) (216) as salt, using the same context information (relying party identifier and user handle) as was used during credential creation. In the preferred embodiment, the key derivation function is HKDF-SHA256 as defined in RFC 5869. The re-derived credential wrapping key (CWK) (220) is retained only in transient volatile memory of the application's process pending its use in step (410), and is zeroized immediately thereafter.

At step (410), a credential identifier referencing the credential private key (CPK) (222) held within the hardware security module (106) is recovered for use in the subsequent signing step. In the preferred wrapping embodiment, the application processor (104) retrieves the stored wrapped credential record from the non-volatile storage of the mobile device (100) and unwraps the wrapped credential record using the re-derived credential wrapping key (CWK) (220) by application of the key unwrapping algorithm or authenticated decryption algorithm corresponding to the wrapping algorithm employed at step (310) (such as AES-256-Key Unwrap as defined in RFC 3394), in transient volatile memory of the application's process, recovering the plaintext credential record and parsing therefrom the credential identifier; the credential private key (CPK) (222) referenced by the credential identifier remains hardware-bound within the hardware security module (106) and is not extracted from the hardware security module (106). In the alternative deterministic-derivation embodiment, the credential identifier corresponds to the credential private key (CPK) (222) previously imported into the hardware security module (106) at credential-creation time, and the credential identifier is recoverable from device-local credential metadata. In both embodiments, the plaintext credential record (if any) and the re-derived credential wrapping key (CWK) (220) are zeroized from transient volatile memory of the application's process immediately after the credential identifier has been recovered, and the private half of the credential private key (CPK) (222) remains hardware-bound within the hardware security module (106) throughout.

At step (412), the application processor (104) constructs in transient volatile memory of the application's process an assertion comprising authenticator data including the relying party identifier hash, user presence and user verification flags, and an incremented sign count, and computes a digest over the concatenation of the authenticator data and a hash of the client data, the client data including the challenge, the origin, and the type of WebAuthn ceremony. The application processor (104) submits the digest and the credential identifier recovered at step (410) to the hardware security module (106), and the hardware security module (106) produces an ECDSA P-256 (ES256) digital signature over the digest using the hardware-bound credential private key (CPK) (222) referenced by the credential identifier, conditioned on a successful biometric-authentication result reported by the platform biometric subsystem of the mobile device (100). Upon completion of the signing operation, the proprietary biometric key (PBK) (206) and the credential wrapping key (CWK) (220) are zeroized from transient volatile memory of the application's process, and the private half of the credential private key (CPK) (222) remains hardware-bound within the hardware security module (106).

At step (414), the mobile device (100) transmits the assertion and authenticator data to the relying party server (114) via the network (112) for verification by the credential verification module (116). The relying party server (114) verifies the assertion by confirming that the ECDSA signature is valid against the stored credential public key, that the challenge matches the challenge issued by the relying party server (114), that the origin is correct, and that the sign count has incremented relative to the previously stored sign count. In one embodiment, the relying party server (114) is configured to maintain the sign count per credential in the account store (120), to increment the sign count upon each successful authentication ceremony, and to reject an assertion when the received sign count is not incremented relative to the stored sign count, thereby preventing replay attacks from cloned credentials. Upon successful verification, the relying party server (114) grants access to the authenticated user. The cross-device recovery flow, wherein a user establishes credentials on a new device after losing or replacing their old device, is further elaborated in the description of FIG. 5.

Referring now to FIG. 5, a cross-device recovery flow for re-establishing FIDO2 credentials on a new device is illustrated, in accordance with an embodiment of the present subject matter. The cross-device recovery flow enables a user who has lost, broken, or replaced their old device (500) to re-establish their FIDO2 credential on a new device (502) without requiring server-side key backup, without requiring manual identity re-verification by a human administrator, and without requiring out-of-band communication channels. For example, when a user's smartphone is lost or damaged, the user obtains a new smartphone and initiates the recovery process by installing the client application, re-presenting the same identity-anchor record that was used during original registration, and providing a fresh biometric sample on the new device. In one embodiment, the system is configured to perform the cross-device recovery flow when a user replaces the old device (500) with the new device (502).

In the cross-device recovery flow, the user installs the client application on the new device (502) and initiates the recovery process. The identity-anchor record (504), which is the same identity-anchor record that was used during the original credential creation on the old device (500), serves as the recovery vector. The user presents the identity-anchor record (504) to the new device (502) for extraction.

At step (506), the new device (502) captures a biometric sample from the user using the biometric sensor of the new device (502). The biometric sample is processed by the application processor of the new device (502) in transient volatile memory of the application's process to compute a new proprietary biometric key (PBK), which is retained only in transient volatile memory of the application's process pending its use in step (510). This new proprietary biometric key (PBK) may differ from the proprietary biometric key (PBK) (206) generated on the old device (500) because the biometric sensor on the new device (502) may have different capture characteristics, and the biometric sample conditions may differ from those during the original registration.

At step (508), the new device (502) re-extracts attribute fields from the identity-anchor record (504) using the identity-anchor record acquisition module of the new device (502) to regenerate the document hash (DocHash) (216). The identity-anchor record acquisition module extracts the attribute fields from the identity-anchor record (504) and the application processor canonicalizes the fields using the same canonicalization procedure described with reference to the canonicalization step (212) of FIG. 2. The canonicalized fields are hashed using the same zero-knowledge-friendly hash function with the same domain separator, producing a regenerated document hash (DocHash) (216). Because the identity-anchor record (504) is the same record and the canonicalization and hashing procedures are deterministic, the regenerated document hash (DocHash) (216) is identical to the original document hash (DocHash) (216) generated during the initial registration on the old device (500). This deterministic property of the document hash (DocHash) (216) is the foundation of the cross-device recovery mechanism.

At step (510), the application processor of the new device (502) derives a new credential wrapping key (CWK) in transient volatile memory of the application's process using the new proprietary biometric key (PBK) and the regenerated document hash (DocHash) (216), applying the same key derivation function (HKDF-SHA256) with the same relying party identifier and user handle as the info parameter. The new credential wrapping key (CWK) may differ from the original credential wrapping key (CWK) (220) because the new proprietary biometric key (PBK) differs from the original, but the document hash (DocHash) (216) component remains constant, providing identity continuity.

At step (512), a new credential private key (CPK) is established on the new device (502) such that the private half of the new credential private key (CPK) is hardware-bound and non-extractable within the hardware security module of the new device (502), and use of the new credential private key (CPK) is bound to the new credential wrapping key (CWK) in accordance with one of the two embodiments described with reference to paragraph 51. A corresponding new credential public key is computed from the new credential private key (CPK) by the hardware security module of the new device (502) and is exported to the application processor of the new device (502). Because the new credential wrapping key (CWK) differs from the original, the new credential private key (CPK) and its corresponding public key will also differ from the original credential. However, the document hash (DocHash) (216) remains constant, providing the cryptographic anchor for account identity continuity on the relying party server (514).

The new device (502) transmits a recovery request to the relying party server (514) comprising the regenerated document hash (DocHash) (216) and the new credential public key. The recovery request includes a recovery indicator that signals to the relying party server (514) that this is a cross-device recovery attempt rather than a new user registration. The relying party server (514) receives the recovery request via the network.

At step (516), the relying party server (514) matches the regenerated document hash (DocHash) (216) with an existing entry in the deduplication database (118) to identify an existing account associated with the same document hash. The matching operation involves querying the deduplication database (118) using the regenerated document hash (DocHash) (216) as the search key. Because the document hash (DocHash) (216) is deterministic and identical for the same identity-anchor record, the relying party server (514) can reliably identify the user's original account registration. In some embodiments, the relying party server (514) performs additional verification checks before approving the recovery, including verifying a WebAuthn assertion signature using the new credential public key, and confirming that a grace period has elapsed since the original credential registration or requiring manual approval via a second authentication factor.

At step (518), the relying party server (514) migrates the existing account to a new credential associated with the new credential private key (CPK) generated on the new device (502). The migration comprises revoking the old credential associated with the old device (500), storing the new credential public key in the account store (120) in association with the existing user identifier, and preserving all account data and permissions including account balance, access rights, and metadata. The document hash (DocHash) (216) entry in the deduplication database (118) remains unchanged and continues to be linked to the migrated account, maintaining the Sybil resistance properties of the system. This approach requires no server-side key backup and no out-of-band communication. The identity-anchor record (504) itself serves as the recovery vector, preventing account hijacking by someone who steals the user's phone but does not possess the user's identity-anchor record.

The cross-device recovery flow of FIG. 5 represents a technical advancement over existing FIDO2 recovery mechanisms. Conventional FIDO2 passkey recovery approaches either rely on server-side backup of the credential private key, which undermines security by centralizing key material in a cloud provider's infrastructure, or require manual credential re-enrollment without any automated means to verify that the same physical person is registering the new credential. The present invention leverages the deterministic document hash (DocHash) (216) as a cross-device identity anchor, enabling automated recovery verification without exposing the credential private key to any server. The specific details of the deduplication mechanism that enables the relying party server (114) to distinguish between legitimate recovery attempts and fraudulent duplicate registration attempts are further elaborated in the description of FIG. 6.

Referring now to FIG. 6, a deduplication mechanism for enforcing Sybil resistance is illustrated, in accordance with an embodiment of the present subject matter. FIG. 6 depicts two scenarios that illustrate how the relying party server uses the document hash (DocHash) (216) stored in the deduplication database to prevent a single individual from registering multiple accounts. The deduplication database (118) is configured to enforce Sybil resistance by storing document hash entries, checking for duplicates upon registration attempts, and distinguishing between duplicate registration attempts and legitimate cross-device recovery attempts.

In a first scenario depicted in FIG. 6, a user A (600) performs an initial credential registration. The user A (600) follows the credential creation ceremony described with reference to FIG. 3, capturing their biometric sample, presenting their identity-anchor record, deriving key material, and generating a FIDO2 credential. A credential A (602) comprising a credential public key and a document hash (DocHash_A) is transmitted to the relying party (604). The relying party (604) queries the deduplication database (606) using DocHash_A as the search key. Because this is the first registration by this individual, no matching entry is found in the deduplication database (606). The relying party (604) stores DocHash_A in the deduplication database (606) as a new entry linked to user A's account, and stores the credential public key in the account store. The registration succeeds.

In a second scenario depicted in FIG. 6, the same individual, referred to as user A (again) (608), attempts a subsequent registration with the relying party (612) using a different credential B (610). The user A (again) (608) may attempt this registration using a different username, a different email address, or a different phone number in an effort to create a second account. However, because the user A (again) (608) presents the same identity-anchor record during credential creation, the document hash computed from the canonicalized attribute fields is the same DocHash_A. The credential B (610) comprises a different credential public key but the same DocHash_A. The relying party (612) performs a deduplication check (614) by querying the deduplication database using DocHash_A as the search key. The deduplication check (614) finds a matching entry because DocHash_A was already stored during the first registration in the first scenario. For example, if an individual who registered as “john_smith” at “login.example.com” attempts to create a second account as “j.smith.new” using a different email address but presents the same passport during identity-anchor record extraction, the system computes the same DocHash_A from the same passport fields, and the deduplication check (614) identifies the duplicate. The relying party (612) rejects the subsequent registration attempt, thereby preventing the same individual from registering multiple accounts, even if they attempt to register with different usernames, email addresses, or phone numbers.

In one embodiment, the deduplication database (118) is further configured to distinguish between a duplicate registration attempt and a cross-device recovery attempt based on a recovery indicator included in a credential registration request. When a registration request includes the recovery indicator, as described with reference to FIG. 5, the relying party server (114) recognizes this as a recovery scenario rather than a Sybil attack. In the recovery scenario, the relying party server (114) does not reject the request despite finding a matching document hash entry; instead, it performs the recovery verification checks described with reference to steps (516) and (518) of FIG. 5 and, upon successful verification, migrates the existing account to the new credential. When a registration request does not include the recovery indicator, the relying party server (114) treats the matching document hash as a duplicate registration attempt and rejects it.

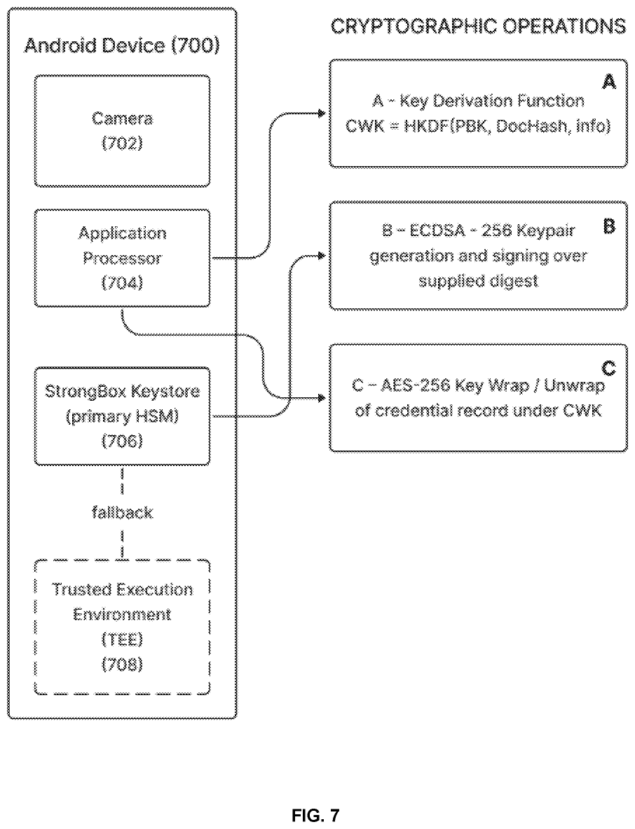

In one embodiment, the document hash (DocHash) (216) is computed with a domain separator that does not include the relying party identifier, such that the same user will have the same document hash (DocHash) (216) across all relying parties using the system. This enables cross-relying-party Sybil resistance. In some embodiments, the document hash (DocHash) (216) computation is modified to include the relying party identifier in the domain separator or in the canonical input, such that the same user will have different document hashes across different relying parties. This alternative construction enables relying-party-isolated deduplication and prevents cross-relying-party linking of accounts, providing enhanced privacy by preventing different relying parties from correlating user identities through shared document hash values. The selection between cross-relying-party deduplication and relying-party-isolated deduplication is determined by the deployment requirements and privacy policies of the relying party. The alternative embodiment using Android StrongBox as the hardware security module is further elaborated in the description of FIG. 7.

Referring now to FIG. 7, an alternative embodiment of the system using an Android StrongBox Keystore as the hardware security module is illustrated, in accordance with an embodiment of the present subject matter. FIG. 7 depicts an Android device (700) that implements the same key derivation and credential management functionality described with reference to FIGS. 1 through 6, but using the Android-specific hardware security architecture. The Android device (700) comprises a camera (702), an application processor (704), a StrongBox Keystore (706), and a Trusted Execution Environment (TEE) (708).

In one embodiment, the camera (702) of the Android device (700) serves as the biometric sensor for capturing facial data from the user. The camera (702) is a front-facing camera configured to capture images of the user's face for facial recognition. The camera (702) corresponds to the biometric sensor (102) described with reference to FIG. 1 and performs the biometric capture step (200) of the key derivation pipeline described with reference to FIG. 2. In some embodiments, the Android device (700) additionally or alternatively comprises a fingerprint sensor for capturing fingerprint data, or other biometric sensors for capturing iris or voice data.

In one embodiment, the application processor (704) of the Android device (700) is a system-on-chip that corresponds to the application processor (104) described with reference to FIG. 1. The application processor (704) executes the Android operating system and application software that orchestrates the biometric capture, identity-anchor record extraction, and credential management workflows. For example, on Android devices such as those equipped with a Titan M security chip or equivalent dedicated security coprocessor, the application processor (704) interfaces with the StrongBox Keystore (706) via the Android Keystore API, using the setIsStrongBoxBacked( ) parameter to direct cryptographic operations to the dedicated StrongBox hardware module.

In one embodiment, the StrongBox Keystore (706) is a dedicated tamper-resistant key store that corresponds to the hardware security module (106) described with reference to FIG. 1. The StrongBox Keystore (706) is a tamper-resistant hardware component physically separate from the application processor (704). The StrongBox Keystore (706) performs the cryptographic operation depicted in FIG. 7 as operation B, namely ECDSA P-256 keypair generation to produce the credential private key (CPK) (222) and the corresponding credential public key, wherein the private half of the credential private key (CPK) (222) is hardware-bound and non-extractable from the StrongBox Keystore (706); and ECDSA P-256 signature generation over a digest supplied by the application processor (704), using the hardware-bound private half of the credential private key (CPK) (222), conditioned on a successful biometric-authentication result reported by the platform biometric subsystem of the Android device (700). The cryptographic operation depicted in FIG. 7 as operation A, namely key derivation by application of a key derivation function (for example, HKDF-SHA256 as defined in RFC 5869) to compute the credential wrapping key (CWK) (220) from the proprietary biometric key (PBK) (206) and the document hash (DocHash) (216), and the cryptographic operation depicted in FIG. 7 as operation C, namely a key wrapping algorithm or authenticated-encryption-with-associated-data algorithm (for example, AES-256-Key Wrap as defined in RFC 3394, AES-256-GCM, or another authenticated-encryption construction) and the corresponding key unwrapping or authenticated decryption algorithm, involving the credential wrapping key (CWK) (220) and a credential record referencing the credential private key (CPK) (222), are performed by the application processor (704) in transient volatile memory of the application's process; the intermediate values produced by operations A and C, including the proprietary biometric key (PBK) (206), the credential wrapping key (CWK) (220), and the plaintext credential record, are retained only in transient volatile memory of the application's process and are zeroized immediately after use. The StrongBox Keystore (706) ensures that the private half of the credential private key (CPK) (222) is not exposed to the operating system of the Android device (700) or to application software of the Android device (700) in plaintext form.

In one embodiment, the Trusted Execution Environment (TEE) (708) is a secure processing environment within the application processor (704) of the Android device (700) that is used as a fallback for devices without dedicated StrongBox hardware. The TEE (708) provides a less isolated but still secure execution environment compared to the StrongBox Keystore (706). The TEE (708) runs a separate trusted operating system alongside the main Android operating system and provides hardware-backed isolation of cryptographic key material and operations. On Android devices that include both the StrongBox Keystore (706) and the TEE (708), the system preferentially uses the StrongBox Keystore (706) for all cryptographic operations due to its higher level of hardware isolation. On Android devices that do not include dedicated StrongBox hardware, the system falls back to the TEE (708) to perform the same credential private key (CPK) (222) generation and ECDSA signature operations described with reference to operation B, while the application processor (704) performs operations A and C in transient volatile memory of the application's process as described with reference to paragraph 88, providing equivalent functional security with a reduced hardware isolation guarantee.

The Android StrongBox embodiment of FIG. 7 demonstrates that the present invention is not limited to any specific hardware security module implementation. The system architecture is designed to be hardware-agnostic, supporting Apple Secure Enclave on iOS devices, Android StrongBox Keystore and TEE on Android devices, Windows Hello and Trusted Platform Module (TPM) on desktop computing devices, and generic hardware security modules or cryptographic accelerators that support ECDSA signing and key generation. The functional requirements of the hardware security module (106) are: internal asymmetric keypair generation with a hardware-bound non-extractable private half, support for ECDSA P-256 (or alternative asymmetric) signing on a supplied digest, platform-mediated biometric-gated authorization of key use, and isolation of the private half from the main operating system such that key material is not accessible to application software.

In alternative embodiments, the system may be implemented with different cryptographic hash functions, key derivation functions, signature algorithms, and hardware configurations. The present invention is not limited to the specific cryptographic primitives described in the preferred embodiments; rather, the cryptographic primitives may be selected based on the security requirements, performance characteristics, and hardware capabilities of the deployment environment.

In some embodiments, the zero-knowledge-friendly hash function used to compute the document hash (DocHash) (216) is selected from the group consisting of Pedersen hash, Mimc hash, Poseidon hash variants, or other arithmetic-friendly hash functions designed for efficient computation within zero-knowledge proof circuits. In other embodiments, classical cryptographic hash functions such as SHA-256, SHA-3, or BLAKE2 are used for computing the document hash (DocHash) (216) when zero-knowledge proof compatibility is not required. The selection of the hash function does not affect the deterministic property of the document hash (DocHash) (216), as both zero-knowledge-friendly and classical hash functions produce deterministic outputs for identical inputs.

In some embodiments, the key derivation function used to derive the credential wrapping key (CWK) (220) is selected from the group consisting of: HKDF as defined in RFC 5869 instantiated with SHA-256, SHA-3, BLAKE2, or BLAKE3 as the underlying hash function; HKDF-Expand-Label as defined in RFC 8446 (TLS 1.3); PBKDF2 as defined in RFC 8018; Argon2 or Argon2id memory-hard key derivation functions; scrypt as defined in RFC 7914; a key derivation function in accordance with NIST SP 800-108 operating in counter mode, feedback mode, or double-pipeline mode; a key derivation function in accordance with NIST SP 800-56C; KMAC as defined in FIPS SP 800-185; a key derivation function based on cSHAKE, SHAKE128, or SHAKE256 as defined in FIPS 202 or NIST SP 800-185; AES-CMAC-PRF as defined in RFC 4615; an ANSI X9.63 key derivation function; a sponge-construction-based key derivation function; a lattice-based or post-quantum key derivation function; a hash-based key derivation function employing a domain separator; an HMAC-based pseudorandom-function key derivation function; and custom key derivation functions designed for arithmetic constraints of zero-knowledge proof circuits, including Poseidon-based, Mimc-based, and Pedersen-based key derivation functions; and combinations of any of the foregoing. Each of the foregoing constitutes a “key derivation function” as that term is used herein and in the appended claims. The selection of the key derivation function does not affect the fundamental architecture of the key derivation pipeline described with reference to FIG. 2.

In some embodiments, the credential private key (CPK) (222) uses alternative signature algorithms selected from the group consisting of ECDSA with P-384 or P-521 curves, EdDSA with Ed25519 or Ed448 curves, RSA-PSS with 2048-bit or 4096-bit key lengths, or post-quantum cryptographic algorithms such as Dilithium (CRYSTALS-Dilithium) or Falcon, which provide resistance against attacks from quantum computing devices. The system architecture accommodates these alternative signature algorithms by modifying the keypair generation step (310) in the credential creation ceremony and the signing step (412) in the authentication ceremony.

In some embodiments, the identity-anchor record (110) used for document hash computation is selected from the broadened group consisting of: a verifiable credential in W3C Verifiable Credentials format; a self-issued credential wherein identity verification is delegated to the relying party; a mobile driver's license compliant with ISO/IEC 18013-5; an ICAO 9303-compliant electronic travel document; a decentralized identifier (DID) bound to one or more verifiable credentials; an eIDAS digital identity wallet credential; a professional license issued by a recognized authority; an educational credential compliant with the Blockcerts or EBSI standards; an employer-issued credential containing attribute fields authenticated by an employer; and a multi-anchor proof wherein document hashes from a plurality of identity-anchor records are combined through cryptographic aggregation to produce a composite document hash (DocHash) (216). These alternative identity-anchor record types enable the system to adapt to different jurisdictions, identity-verification frameworks, and trust models. The canonicalization procedure described with reference to the canonicalization step (212) is adapted as appropriate to each identity-anchor record type, including by application of JSON-LD canonicalization schemes such as URDNA2015 for JSON-LD-serialized records, CBOR-deterministic encoding (RFC 8949 § 4.2.1) for CBOR-serialized records, and uniform-case conversion with diacritic handling for text-serialized records.

In one embodiment, the system and method described with reference to FIGS. 1 through 7 may be embodied as a computer program product comprising a non-transitory computer-readable storage medium having program instructions embodied therewith. The non-transitory computer-readable storage medium may include any computer-readable medium known in the art including, for example, volatile memory such as static random-access memory (SRAM) and dynamic random-access memory (DRAM), and non-volatile memory such as read-only memory (ROM), erasable programmable ROM, flash memories, hard disks, solid-state drives, optical disks, and memory cards. The program instructions are executable by the application processor (104) of the mobile device (100) equipped with the biometric sensor (102), the hardware security module (106), and the identity-anchor record acquisition module (108), for performing the operations of capturing a biometric sample, computing the proprietary biometric key (PBK) (206), extracting attribute fields from the identity-anchor record (110), computing the document hash (DocHash) (216), deriving the credential wrapping key (CWK) (220), establishing the credential private key (CPK) (222) within the hardware security module (106), creating and signing WebAuthn attestation and assertion objects, and transmitting the signed objects and the document hash (DocHash) (216) to the relying party server (114) for verification and storage in the deduplication database (118). The program instructions, when executed, cause the application processor (104) to perform, in transient volatile memory of the application's process, the operations of biometric feature extraction, proprietary biometric key computation, identity-anchor record field canonicalization, document hash computation, credential wrapping key derivation, and credential-record wrap and unwrap operations described herein, and to coordinate with the hardware security module (106) such that the credential private key (CPK) (222) is generated within, held within, and used for ECDSA signature operations within the hardware security module (106) with the private half of the credential private key (CPK) (222) hardware-bound and non-extractable as described herein.

The present invention provides a technical advancement in the field of cryptographic key derivation, passwordless authentication, and identity verification. The disclosed computer-implemented system addresses limitations of existing FIDO2 implementations and biometric authentication approaches through several specific technical improvements.

Firstly, the composite key derivation architecture, wherein use of the credential private key (CPK) (222) is bound to the combination of the proprietary biometric key (PBK) (206) and the document hash (DocHash) (216), creates an intrinsic cryptographic link between the authentication credential and the user's verified identity. Existing FIDO2 implementations generate credential private keys using cryptographically secure random number generators, which provides cryptographic security but creates no link between the credential and the user's identity. The present invention's composite key construction eliminates the need for separate identity verification flows alongside the FIDO2 authentication, reducing system complexity, eliminating dual cryptographic flow overhead, and providing a unified authentication and identity verification mechanism.

Secondly, the proprietary biometric key (PBK) (206) is computed without persisting any biometric template, eliminating privacy and security risks associated with persistent biometric template storage.

Thirdly, the cross-device recovery mechanism, wherein the deterministic document hash (DocHash) (216) serves as a cross-device identity anchor that enables automated account migration without server-side key backup, addresses a fundamental limitation of existing FIDO2 recovery approaches. Conventional FIDO2 passkey recovery either relies on cloud-based key backup, which centralizes sensitive key material and creates a single point of failure, or requires manual re-enrollment without automated identity verification. The present invention leverages the deterministic property of the document hash (DocHash) (216) to enable the relying party server (114) to automatically verify that the user on the new device is the same individual who originally registered, based on possession of the same identity-anchor record, without exposing any key material to the server.

Fourthly, the dual-purpose document hash construction, wherein the document hash (DocHash) (216) simultaneously serves as key derivation salt and as a Sybil-resistance deduplication anchor, provides computational efficiency by eliminating the need for separate deduplication infrastructure. The relying party server (114) achieves Sybil resistance by maintaining only a lightweight deduplication database (118) of document hash values, without requiring storage of identity-anchor record images, biometric templates, or third-party identity verification results.

Fifthly, the layered key-protection architecture, wherein the private half of the credential private key (CPK) (222) is hardware-bound and non-extractable within the hardware security module (106) and is used only for platform-mediated, biometric-gated ECDSA signature operations by the hardware security module (106), while the proprietary biometric key (PBK) (206) and the credential wrapping key (CWK) (220) are computed by the application processor (104) only in transient volatile memory of the application's process and are zeroized immediately after each use, provides defense in depth against operating-system compromise, malicious application software, and side-channel attacks: an attacker who compromises the device at rest finds no persisted biometric template, no persisted proprietary biometric key (PBK) (206), and no persisted credential wrapping key (CWK) (220), while an attacker who compromises the application's process at the precise instant of credential creation or authentication cannot extract the private half of the credential private key (CPK) (222), which remains hardware-bound within the hardware security module (106) at all times.

The foregoing description presents exemplary embodiments for purposes of illustration and enablement. The invention is not limited to the precise forms disclosed. Modifications and variations are possible in light of the above teachings or may be acquired from practice of the invention, and may be made without departing from the scope of the appended claims. The embodiments were selected to explain principles and practical applications, enabling others skilled in the art to utilize the invention in various embodiments and with various modifications as suited to the particular use contemplated. The scope of the invention is defined by the appended claims and their equivalents.

1. A system for generating identity-anchored biometrics-based credential keys, the system comprising:
a mobile device (100) comprising a biometric sensor (102), an application processor (104), a hardware security module (106), and an identity-anchor record acquisition module (108);
a network (112) communicatively coupling the mobile device (100) to a relying party server (114);
the relying party server (114) comprising a credential verification module (116), a deduplication database (118), and an account store (120), wherein the application processor (104) is configured to execute programmed instructions for:
capturing (200), by the biometric sensor (102), a biometric sample from a user in real-time;
computing (204), by the application processor (104) in transient volatile memory of an application's process, a proprietary biometric key (PBK) (206) by processing the captured biometric sample, wherein the computed proprietary biometric key (PBK) (206) is retained only in transient volatile memory of the application's process, is zeroized after derivation therefrom of the credential wrapping key (CWK) (220), and is not persisted to non-volatile storage;
extracting (210), by the identity-anchor record acquisition module (108), attribute fields from an identity-anchor record (110), the attribute fields comprising one or more attributes selected from the group consisting of: a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record (110), wherein the attribute fields in combination deterministically distinguish the individual from other individuals within a relevant population;
cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails;
canonicalizing (212) the extracted attribute fields by application of a canonicalization procedure adapted to a serialization format of the identity-anchor record (110), the canonicalization procedure comprising one or more operations selected from: normalizing whitespace, handling diacritics, applying uniform case conversion, JSON-LD canonicalization in accordance with URDNA2015, CBOR-deterministic encoding in accordance with RFC 8949 Section 4.2.1, and a combination of the foregoing, to produce canonicalized attribute fields;
computing (214) a document hash (DocHash) (216) by applying a cryptographic hash function to a canonical byte representation constructed from the canonicalized attribute fields and, where the identity-anchor record (110) contains a photograph, biometric reference, or other binary attachment, a cryptographic hash of bytes of the photograph, biometric reference, or binary attachment, with a domain separator, wherein the computed document hash (DocHash) (216) is deterministic such that a same identity-anchor record (110) produces a same document hash (DocHash) (216);
deriving (218), by the application processor (104) in transient volatile memory of the application's process, a credential wrapping key (CWK) (220) by applying a key derivation function with the computed proprietary biometric key (PBK) (206) as input key material, the computed document hash (DocHash) (216) as salt, and context information comprising a relying party identifier and a user handle as an info parameter, wherein the derived credential wrapping key (CWK) (220) is retained only in transient volatile memory of the application's process and is zeroized immediately after use;
generating, by the hardware security module (106), a credential private key (CPK) (222) such that the private half of the credential private key (CPK) (222) is hardware-bound, non-extractable, and never leaves the hardware security module (106) in plaintext, and binding use of the credential private key (CPK) (222) to a combination of the computed proprietary biometric key (PBK) (206), the computed document hash (DocHash) (216), and the relying party identifier by means of the derived credential wrapping key (CWK) (220);
signing an attestation object using the generated credential private key (CPK) (222), the attestation object comprising a credential public key derived from the credential private key (CPK) (222);
transmitting the signed attestation object and the computed document hash (DocHash) (216) to the relying party server (114) via the network (112); and
wherein the relying party server (114) is configured to:
verify, by the credential verification module (116), the transmitted attestation object;
store the computed document hash (DocHash) (216) in the deduplication database (118) and the credential public key in the account store (120); and
check the deduplication database (118) upon a credential registration attempt to reject registration when the computed document hash (DocHash) (216) matches an existing entry in the deduplication database (118) to prevent a single individual from registering multiple accounts.

2. The system as claimed in claim 1, wherein the key derivation function used for deriving the credential wrapping key (CWK) (220) is HKDF-SHA256 as defined in RFC 5869, wherein the info parameter comprises a protocol version string concatenated with the relying party identifier and the user handle.

3. The system as claimed in claim 1, wherein the credential private key (CPK) (222) is an ECDSA P-256 keypair with a signature algorithm ES256 as defined in COSE RFC 8152, and wherein the credential public key is computed from the credential private key (CPK) (222) using ECDSA P-256 public key derivation.

4. The system as claimed in claim 1, wherein the biometric sample captured by the biometric sensor (102) comprises one or more modalities selected from a group consisting of:
facial recognition data obtained by a front-facing camera of the mobile device (100);
fingerprint data obtained by a fingerprint sensor of the mobile device (100);
iris recognition data obtained by an iris recognition sensor; and
voice recognition data obtained by an audio capture device.

5. The system as claimed in claim 1, wherein the application processor (104) is further configured to perform an authentication ceremony comprising:
receiving (402) a challenge and credential identifiers from the relying party server (114);
capturing (404) a biometric sample from the user in real-time to derive a fresh proprietary biometric key (PBK) (206);
retrieving (406) the stored document hash (DocHash) (216) from a secure storage of the mobile device (100);
re-deriving (408) the credential wrapping key (CWK) (220) by applying the key derivation function with the fresh proprietary biometric key (PBK) (206) as input key material and the retrieved document hash (DocHash) (216) as salt;
recovering (410), by the application processor (104) in transient volatile memory of the application's process, a credential identifier referencing the credential private key (CPK) (222) held within the hardware security module (106), by unwrapping a stored wrapped credential record using the re-derived credential wrapping key (CWK) (220), wherein the private half of the credential private key (CPK) (222) remains hardware-bound within the hardware security module (106) throughout the recovery;
signing (412), by the hardware security module (106), a digest of authenticator data and client data corresponding to the challenge, using the hardware-bound credential private key (CPK) (222) referenced by the recovered credential identifier, to generate an assertion; and
transmitting (414) the assertion and authenticator data to the relying party server (114) for verification by the credential verification module (116).

6. The system as claimed in claim 1, wherein the system is further configured to perform a cross-device recovery flow when a user replaces an old device (500) with a new device (502), the cross-device recovery flow comprising:
re-extracting (508) attribute fields from the identity-anchor record (504) on the new device (502) to regenerate the document hash (DocHash) (216), wherein the regenerated document hash (DocHash) (216) is identical to an original document hash (DocHash) (216) generated during initial registration;
capturing (506) a biometric sample on the new device (502) to derive a new proprietary biometric key (PBK);
deriving (510) a new credential wrapping key (CWK) using the new proprietary biometric key (PBK) and the regenerated document hash (DocHash) (216);
generating (512) a new credential private key (CPK) on the new device (502);
transmitting a recovery request to the relying party server (514) comprising the regenerated document hash (DocHash) (216);
matching (516), by the relying party server (514), the regenerated document hash (DocHash) (216) with an existing entry in the deduplication database (118) to identify an existing account; and
migrating (518) the existing account to a new credential associated with the new credential private key (CPK) generated on the new device (502), wherein account data and permissions are preserved.

7. The system as claimed in claim 1, wherein the identity-anchor record (110) is selected from the group consisting of:
a government-issued passport compliant with the ICAO 9303 standard, wherein the attribute fields are extracted from an embedded NFC chip and are cryptographically verified against a digital signature of the NFC chip;
a government-issued driver's license;
a government-issued national identity card;
a mobile driver's license compliant with ISO/IEC 18013-5;
a verifiable credential in W3C Verifiable Credentials format, wherein the attribute fields are extractable from a JSON-LD or JSON Web Token serialization and are cryptographically verified against a digital signature of an issuer of the verifiable credential;
a decentralized identifier (DID) bound to one or more verifiable credentials;
a credential issued under an eIDAS digital identity wallet framework;
a professional license issued by a recognized authority;
an educational credential compliant with a Blockcerts or EBSI standard;
an employer-issued credential containing attribute fields authenticated by an employer; and
any other tangible or digital record containing attribute fields that are authenticated by a trusted source and that, in combination, deterministically distinguish the individual.

8. The system as claimed in claim 1, wherein the deduplication database (118) is configured to enforce Sybil resistance by:
storing (606) a document hash (DocHash) (216) entry upon a successful first registration (600) of the user;
checking (614) the deduplication database (118) upon a subsequent registration attempt (608) by the same individual with a different credential (610);
rejecting the subsequent registration attempt when the document hash (DocHash) (216) in the subsequent registration attempt matches an existing document hash (DocHash) (216) entry in the deduplication database (118); and
distinguishing between a duplicate registration attempt and a cross-device recovery attempt based on a recovery indicator included in a credential registration request.

9. The system as claimed in claim 1, wherein the hardware security module (106) is one of:
an Apple Secure Enclave accessed via a Security framework on iOS;
an Android StrongBox Keystore (706) accessed via an Android Keystore API; or
an Android Trusted Execution Environment (TEE) (708) used as a fallback for devices without dedicated StrongBox hardware, and wherein the hardware security module (106) is configured to hold the private half of the credential private key (CPK) (222) such that the private half is hardware-bound and non-extractable, and to perform ECDSA signature operations using the hardware-bound private half conditioned on a successful biometric-authentication result reported by a platform biometric subsystem of the mobile device (100), such that the private half of the credential private key (CPK) (222) is not exposed to an operating system of the mobile device (100) in plaintext form.

10. The system as claimed in claim 1, wherein the key derivation function used for deriving the credential wrapping key (CWK) (220) is selected from the group consisting of: HKDF as defined in RFC 5869; HKDF instantiated with SHA-256, SHA-3, BLAKE2, or BLAKE3 as an underlying hash function; HKDF-Expand-Label as defined in RFC 8446; PBKDF2 as defined in RFC 8018; Argon2 or Argon2id; scrypt as defined in RFC 7914; a key derivation function in accordance with NIST SP 800-108; a key derivation function in accordance with NIST SP 800-56C; KMAC as defined in FIPS SP 800-185; a key derivation function based on cSHAKE, SHAKE128, or SHAKE256 as defined in FIPS 202 or NIST SP 800-185; AES-CMAC-PRF as defined in RFC 4615; an ANSI X9.63 key derivation function; a sponge-construction-based key derivation function; a lattice-based or post-quantum key derivation function; a hash-based key derivation function employing a domain separator; an HMAC-based pseudorandom-function key derivation function; and combinations of any of the foregoing.

11. The system as claimed in claim 1, wherein the key wrapping algorithm used for wrapping the credential record under the credential wrapping key (CWK) (220) is selected from the group consisting of: AES-256-Key Wrap as defined in RFC 3394; AES Key Wrap with Padding as defined in RFC 5649; AES-256-GCM; AES-256-SIV; AES-256-CCM; ChaCha20-Poly1305; and another authenticated-encryption-with-associated-data construction.

12. The system as claimed in claim 1, wherein the credential private key (CPK) (222) is generated by the hardware security module (106) as a keypair under an asymmetric signature algorithm selected from the group consisting of: ECDSA over the NIST P-256 curve with signature algorithm ES256 as defined in COSE RFC 8152; ECDSA over the NIST P-384 curve with signature algorithm ES384; ECDSA over the NIST P-521 curve with signature algorithm ES512; EdDSA over the Ed25519 curve; EdDSA over the Ed448 curve; RSA-PSS with an RSA modulus of 2048 bits or greater; CRYSTALS-Dilithium; and Falcon.

13. The system as claimed in claim 1, wherein the credential private key (CPK) (222) is a credential private key, wherein the attestation object signed at credential creation is an attestation object, and wherein the credential private key (CPK) (222), the attestation object, and any subsequent authentication assertion produced thereunder are compliant with the FIDO2 specification of the FIDO Alliance and the WebAuthn specification of the World Wide Web Consortium (W3C), and wherein the credential verification module (116) of the relying party server is implemented as a credential verification module compliant with the W3C WebAuthn specification.

14. A method for generating identity-anchored biometrics-based credential keys, the method comprising steps of:
receiving (302), by a relying party server (114), a credential creation request comprising a challenge, a relying party identifier, and user information, and transmitting the credential creation request to a mobile device (100) via a network (112);
capturing (304), by the mobile device (100), a biometric sample from a user in real-time using a biometric sensor (102), computing, by an application processor (104) of the mobile device (100) in transient volatile memory of an application's process, a proprietary biometric key (PBK) (206) by processing the captured biometric sample, and wherein the computed proprietary biometric key (PBK) (206) is retained only in transient volatile memory of the application's process and is zeroized after derivation therefrom of a credential wrapping key (CWK) (220);
extracting (306), by the mobile device (100) using an identity-anchor record acquisition module (108), attribute fields from an identity-anchor record (110), the attribute fields comprising one or more attributes selected from the group consisting of: a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record (110), wherein the attribute fields, in combination, deterministically distinguish the individual from other individuals within a relevant population, cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails, canonicalizing the extracted attribute fields by application of a canonicalization procedure adapted to a serialization format of the identity-anchor record (110), and computing a document hash (DocHash) (216) by applying a cryptographic hash function to a canonical byte representation constructed from the canonicalized attribute fields and, where the identity-anchor record (110) contains a photograph, biometric reference, or other binary attachment, a cryptographic hash of bytes of the photograph, biometric reference, or binary attachment, with a domain separator, wherein the computed document hash (DocHash) (216) is deterministic such that a same identity-anchor record (110) produces a same document hash (DocHash) (216);
deriving (308), by the application processor (104) in transient volatile memory of the application's process, a credential wrapping key (CWK) (220) by applying a key derivation function with the computed proprietary biometric key (PBK) (206) as input key material, the computed document hash (DocHash) (216) as salt, and context information comprising the relying party identifier and a user handle as an info parameter, wherein the derived credential wrapping key (CWK) (220) is retained only in transient volatile memory of the application's process and is zeroized immediately after use;
generating (310), by the hardware security module (106), a credential private key (CPK) (222) such that the private half of the credential private key (CPK) (222) is hardware-bound, non-extractable, and never leaves the hardware security module (106) in plaintext, and binding use of the credential private key (CPK) (222) to a combination of the computed proprietary biometric key (PBK) (206), the computed document hash (DocHash) (216), and the relying party identifier by means of the derived credential wrapping key (CWK) (220);
creating (312) an attestation object comprising a credential public key derived from the generated credential private key (CPK) (222) and signing the attestation object using the credential private key (CPK) (222); and
receiving (314), by the relying party server (114), the signed attestation object and the computed document hash (DocHash) (216), verifying the signed attestation object using a credential verification module (116), storing the computed document hash (DocHash) (216) in a deduplication database (118) and the credential public key in an account store (120), and checking the deduplication database (118) upon a credential registration attempt to reject registration when the computed document hash (DocHash) (216) matches an existing entry in the deduplication database (118), thereby preventing a single individual from registering multiple accounts.

15. The method as claimed in claim 14, wherein canonicalizing the extracted attribute fields comprises:
normalizing whitespace in the extracted attribute fields;
handling diacritics consistently across the extracted attribute fields;
applying uniform case conversion to the extracted attribute fields; and
constructing the canonical byte representation by concatenating canonicalized attribute fields and, where applicable, a cryptographic hash of bytes of a photograph, biometric reference, or other binary attachment of the identity-anchor record using a cryptographic hash function.

16. The method as claimed in claim 14, wherein the credential private key (CPK) (222) is associated with the derived credential wrapping key (CWK) (220) by one of:
a wrapping method wherein the hardware security module (106) generates the credential private key (CPK) (222) internally such that the private half of the credential private key (CPK) (222) is hardware-bound and non-extractable, and returns to the application processor (104) a credential identifier referencing the credential private key (CPK) (222), and the application processor (104) wraps in transient volatile memory of the application's process a credential record comprising at least the credential identifier and binding metadata using the credential wrapping key (CWK) (220) as a key encryption key by application of a key wrapping algorithm or authenticated-encryption-with-associated-data algorithm, and stores the wrapped credential record in non-volatile storage of the mobile device (100); or
a deterministic-derivation method wherein the application processor (104) hashes the credential wrapping key (CWK) (220) in transient volatile memory of the application's process, interprets resulting bytes as a scalar in a field of an ECDSA P-256 curve in a valid range of [1, n−1], and imports the scalar into the hardware security module (106) as the credential private key (CPK) (222) via a platform key-import application programming interface, such that following import the private half of the credential private key (CPK) (222) is hardware-bound and non-extractable from the hardware security module (106).

17. The method as claimed in claim 14, wherein the relying party server (114) is further configured to maintain a sign count per credential in the account store (120), and wherein the relying party server (114) is configured to:
increment the sign count upon each successful authentication ceremony;
compare a received sign count in an assertion with the stored sign count; and
reject an assertion when the received sign count is not incremented relative to the stored sign count to prevent replay attacks from cloned credentials.

18. A computer program product for generating identity-anchored biometrics-based credential keys, the computer program product comprising a non-transitory computer-readable storage medium having program instructions embodied therewith, wherein the program instructions are executable by an application processor (104) of a mobile device (100) equipped with a biometric sensor (102), a hardware security module (106), and an identity-anchor record acquisition module (108) for:
capturing a biometric sample from a user in real-time using the biometric sensor (102), and
computing, by the application processor (104) in transient volatile memory of an application's process, a proprietary biometric key (PBK) (206) by processing the captured biometric sample, and wherein the computed proprietary biometric key (PBK) (206) is retained only in transient volatile memory of the application's process and is zeroized after use;
extracting, via the identity-anchor record acquisition module (108), attribute fields from an identity-anchor record (110), the attribute fields comprising one or more attributes selected from the group consisting of: a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record (110), wherein the attribute fields, in combination, deterministically distinguish the individual from other individuals within a relevant population, cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails, canonicalizing the extracted attribute fields by application of a canonicalization procedure adapted to a serialization format of the identity-anchor record (110), and computing a document hash (DocHash) (216) by applying a cryptographic hash function to a canonical byte representation constructed from the canonicalized attribute fields and, where the identity-anchor record (110) contains a photograph, biometric reference, or other binary attachment, a cryptographic hash of bytes of the photograph, biometric reference, or binary attachment, with a domain separator, wherein the computed document hash (DocHash) (216) is deterministic such that a same identity-anchor record (110) produces a same document hash (DocHash) (216);
deriving, by the application processor (104) in transient volatile memory of the application's process, a credential wrapping key (CWK) (220) by applying a key derivation function with the computed proprietary biometric key (PBK) (206) as input key material, the computed document hash (DocHash) (216) as salt, and context information comprising a relying party identifier and a user handle as an info parameter, wherein the derived credential wrapping key (CWK) (220) is retained only in transient volatile memory of the application's process and is zeroized immediately after use;
generating, by the hardware security module (106), a credential private key (CPK) (222) such that the private half of the credential private key (CPK) (222) is hardware-bound, non-extractable, and never leaves the hardware security module (106) in plaintext, and binding use of the credential private key (CPK) (222) to a combination of the computed proprietary biometric key (PBK) (206), the computed document hash (DocHash) (216), and the relying party identifier by means of the derived credential wrapping key (CWK) (220);
creating an attestation object comprising a credential public key derived from the credential private key (CPK) (222) and signing the attestation object using the credential private key (CPK) (222); and
transmitting the signed attestation object and the computed document hash (DocHash) (216) to a relying party server (114) via a network (112) for verification and storage, wherein the relying party server (114) stores the computed document hash (DocHash) (216) in a deduplication database (118) and checks the deduplication database (118) upon a credential registration attempt to reject registration when the computed document hash (DocHash) (216) matches an existing entry to prevent a single individual from registering multiple accounts.

19. A system for enforcing Sybil resistance in user-account registration with cross-device account recovery, the system comprising:
a client device comprising an identity-anchor record acquisition module and a network interface;
a relying party server comprising a deduplication database, an account store, and a network interface; and
a network communicatively coupling the client device to the relying party server; wherein the client device is configured to execute programmed instructions for:
extracting, by the identity-anchor record acquisition module, attribute fields from an identity-anchor record presented by a user, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record, wherein the attribute fields, in combination, deterministically distinguish the individual from other individuals within a relevant population;
cryptographically verifying, by the identity-anchor record acquisition module, the identity-anchor record against a digital signature of an issuer of the identity-anchor record using a public key or a certificate chain of the issuer, and aborting the credential creation ceremony when the cryptographic verification fails;
canonicalizing the extracted attribute fields by application of a canonicalization procedure adapted to a serialization format of the identity-anchor record, to produce canonicalized attribute fields;
computing a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator, wherein the computed document hash (DocHash) is deterministic such that a same identity-anchor record produces a same document hash (DocHash) across different client devices and different extraction sessions; and
transmitting the computed document hash (DocHash) to the relying party server via the network, in association with a credential registration request, without transmitting the underlying attribute fields;
and wherein the relying party server is configured to execute programmed instructions for:
receiving the transmitted document hash (DocHash);
determining whether the received document hash (DocHash) matches an existing entry in the deduplication database;
when the received document hash (DocHash) matches an existing entry in the deduplication database and the credential registration request does not include a recovery indicator, rejecting the credential registration request to prevent a single individual from registering multiple accounts with the relying party server using the same identity-anchor record;
when the received document hash (DocHash) matches an existing entry in the deduplication database and the credential registration request includes a recovery indicator, identifying an existing account in the account store linked to the matching deduplication database entry, and migrating the existing account to a new credential associated with the credential registration request, wherein account data and permissions are preserved across the migration; and
when the received document hash (DocHash) does not match any existing entry in the deduplication database, storing the received document hash (DocHash) in the deduplication database as a new entry linked to a newly-created user-account entry in the account store,
wherein the relying party server does not persist the underlying attribute fields, the deduplication database storing only a cryptographic digest of the canonicalized attribute fields.

20. A method for enforcing Sybil resistance in user-account registration with cross-device account recovery, the method comprising steps of:
extracting, by a client device comprising an identity-anchor record acquisition module, attribute fields from an identity-anchor record presented by a user, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record, wherein the attribute fields, in combination, deterministically distinguish the individual from other individuals within a relevant population;
cryptographically verifying, by the identity-anchor record acquisition module, the identity-anchor record against a digital signature of an issuer of the identity-anchor record using a public key or a certificate chain of the issuer, and aborting the credential creation ceremony when the cryptographic verification fails;
canonicalizing the extracted attribute fields by application of a canonicalization procedure adapted to a serialization format of the identity-anchor record, to produce canonicalized attribute fields;
computing, by the client device, a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator, wherein the computed document hash (DocHash) is deterministic such that a same identity-anchor record produces a same document hash (DocHash) across different client devices and different extraction sessions;
transmitting, by the client device, the computed document hash (DocHash) to a relying party server via a network, in association with a credential registration request, without transmitting the underlying attribute fields;
receiving, by the relying party server, the transmitted document hash (DocHash) and the credential registration request;
determining, by the relying party server, whether the received document hash (DocHash) matches an existing entry in a deduplication database of the relying party server;
rejecting the credential registration request when the received document hash (DocHash) matches an existing entry in the deduplication database and the credential registration request does not include a recovery indicator to prevent a single individual from registering multiple accounts with the relying party server using the same identity-anchor record;
identifying an existing account in an account store of the relying party server linked to the matching deduplication database entry, and migrating the existing account to a new credential associated with the credential registration request with preservation of account data and permissions, when the received document hash (DocHash) matches an existing entry in the deduplication database and the credential registration request includes a recovery indicator; and
storing the received document hash (DocHash) in the deduplication database as a new entry linked to a newly-created user-account entry in the account store, when the received document hash (DocHash) does not match any existing entry in the deduplication database,
wherein the relying party server does not persist the underlying attribute fields, the deduplication database storing only a cryptographic digest of the canonicalized attribute fields.

21. A computer program product for enforcing Sybil resistance in user-account registration with cross-device account recovery, the computer program product comprising a non-transitory computer-readable storage medium having program instructions embodied therewith, wherein the program instructions are executable by at least one processor to perform operations comprising:
extracting, via an identity-anchor record acquisition module of a client device, attribute fields from an identity-anchor record presented by a user, the attribute fields comprising one or more attributes selected from the group consisting of a full legal name, a date of birth, a gender, a photograph or other biometric reference, a national or jurisdictional identifier, an issuer-assigned identifier, an institutional affiliation, a credential issuance date, and a cryptographic signature of an issuer of the identity-anchor record, wherein the attribute fields, in combination, deterministically distinguish the individual from other individuals within a relevant population;
cryptographically verifying, by the identity-anchor record acquisition module, the identity-anchor record against a digital signature of an issuer of the identity-anchor record using a public key or a certificate chain of the issuer, and aborting the credential creation ceremony when the cryptographic verification fails;
canonicalizing the extracted attribute fields by application of a canonicalization procedure adapted to a serialization format of the identity-anchor record, to produce canonicalized attribute fields;
computing a document hash (DocHash) by applying a cryptographic hash function to a canonical byte representation constructed from the canonicalized attribute fields and, where the identity-anchor record contains a photograph, biometric reference, or other binary attachment, a cryptographic hash of bytes of the photograph, biometric reference, or binary attachment, with a domain separator, wherein the computed document hash (DocHash) is deterministic such that a same identity-anchor record produces a same document hash (DocHash) across different client devices and different extraction sessions;
transmitting the computed document hash (DocHash) to a relying party server via a network, in association with a credential registration request, without transmitting the underlying attribute fields;
at the relying party server, determining whether the received document hash (DocHash) matches an existing entry in a deduplication database of the relying party server, and:
rejecting the credential registration request when the received document hash (DocHash) matches an existing entry in the deduplication database and the credential registration request does not include a recovery indicator;
identifying an existing account in an account store of the relying party server linked to the matching deduplication database entry, and migrating the existing account to a new credential associated with the credential registration request with preservation of account data and permissions, when the received document hash (DocHash) matches an existing entry in the deduplication database and the credential registration request includes a recovery indicator; and
storing the received document hash (DocHash) in the deduplication database as a new entry linked to a newly-created user-account entry in the account store, when the received document hash (DocHash) does not match any existing entry in the deduplication database,
wherein the relying party server does not persist the underlying attribute fields, the deduplication database storing only a cryptographic digest of the canonicalized attribute fields.

22. A system for generating and managing a biometrically-authenticated credential key anchored to an identity record, the system comprising a refinement of a biometric-authentication construct in which a Secret-Key (S1) is computed from a biometric sample, a Unique-Number (N1) is obtained, and a Public-Key (P1) is computed as P1=F1(S1, N1) by application of a Function (F1), the system comprising:
a mobile device (100) comprising a biometric sensor (102), an application processor (104), a hardware security module (106), and an identity-anchor record acquisition module (108);
a network (112) communicatively coupling the mobile device (100) to a relying party server (114);
the relying party server (114) comprising a deduplication database (118) and an account store (120), wherein the application processor (104) is configured to execute programmed instructions for:
capturing, by the biometric sensor (102), a biometric sample from a user in real-time;
processing the captured biometric sample, in transient volatile memory of an application's process, to compute the Secret-Key (S1) corresponding to the user, wherein the Secret-Key (S1) comprises a proprietary biometric key (PBK) (206) computed by processing the captured biometric sample;
extracting, by the identity-anchor record acquisition module (108), attribute fields from an identity-anchor record (110) presented by the user, cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails, canonicalizing the extracted attribute fields, and obtaining the Unique-Number (N1) corresponding to the user, wherein the Unique-Number (N1) comprises a deterministic document hash (DocHash) (216) computed by applying a cryptographic hash function to a canonical byte representation of the canonicalized attribute fields with a domain separator, and wherein the Unique-Number (N1) is deterministically computed from the identity-anchor record (110) in lieu of being generated by a random number generation algorithm;
applying, by the application processor (104) in transient volatile memory of the application's process, the Function (F1) to the Secret-Key (S1) and the Unique-Number (N1) to compute the Public-Key (P1), wherein the Function (F1) comprises a key derivation function and the Public-Key (P1) comprises a credential wrapping key (CWK) (220);
generating, by the hardware security module (106), a credential private key (CPK) (222) such that the private half of the credential private key (CPK) (222) is hardware-bound, non-extractable, and never leaves the hardware security module (106) in plaintext;
binding use of the credential private key (CPK) (222) to the Public-Key (P1) by wrapping, in transient volatile memory of the application's process, a credential record referencing the credential private key (CPK) (222) using the Public-Key (P1) as a key encryption key, and storing the wrapped credential record in non-volatile storage of the mobile device (100);
storing the Unique-Number (N1) on the mobile device (100) and transmitting the Unique-Number (N1) and a credential public key derived from the credential private key (CPK) (222) to the relying party server (114) via the network (112) for storage in the deduplication database (118) and the account store (120), respectively; and
authenticating the user in a subsequent authentication ceremony by:
capturing a fresh biometric sample from the user in real-time,
processing the fresh biometric sample, in transient volatile memory of the application's process, to compute a fresh Secret-Key (S2),
retrieving the stored Unique-Number (N1) from the mobile device (100),
applying the Function (F1) to the fresh Secret-Key (S2) and the retrieved Unique-Number (N1) to compute a Real-Time-Public-Key (P2), wherein equivalence of the Real-Time-Public-Key (P2) to the originally-computed Public-Key (P1) constitutes a successful authentication of the user, the equivalence being demonstrated by successful unwrapping of the stored wrapped credential record using the Real-Time-Public-Key (P2) as a key decryption key,
recovering, from the unwrapped credential record, a credential identifier referencing the credential private key (CPK) (222), and
producing, by the hardware security module (106), a digital signature over a digest supplied by the application processor (104) using the hardware-bound credential private key (CPK) (222) referenced by the recovered credential identifier; and
wherein the relying party server (114) is configured to enforce Sybil resistance by checking the deduplication database (118) for an existing entry matching the Unique-Number (N1) upon any credential registration attempt, and rejecting the credential registration attempt when a matching entry is found and the credential registration attempt does not include a recovery indicator.

23. A method for generating and managing a biometrically-authenticated credential key anchored to an identity record, the method comprising a refinement of a biometric-authentication construct in which a Secret-Key (S1) is computed from a biometric sample, a Unique-Number (N1) is obtained, and a Public-Key (P1) is computed as P1=F1(S1, N1) by application of a Function (F1), the method comprising:
capturing, by a biometric sensor (102) of a mobile device (100), a biometric sample from a user in real-time;
processing the captured biometric sample, by an application processor (104) of the mobile device (100) in transient volatile memory of an application's process, to compute the Secret-Key (S1) corresponding to the user, wherein the Secret-Key (S1) comprises a proprietary biometric key (PBK) (206) computed by processing the captured biometric sample;
extracting, by an identity-anchor record acquisition module (108) of the mobile device (100), attribute fields from an identity-anchor record (110) presented by the user, cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails, canonicalizing the extracted attribute fields, and obtaining the Unique-Number (N1) corresponding to the user, wherein the Unique-Number (N1) comprises a deterministic document hash (DocHash) (216) computed by applying a cryptographic hash function to a canonical byte representation of the canonicalized attribute fields with a domain separator, and wherein the Unique-Number (N1) is deterministically computed from the identity-anchor record (110) in lieu of being generated by a random number generation algorithm;
applying, by the application processor (104) in transient volatile memory of the application's process, the Function (F1) to the Secret-Key (S1) and the Unique-Number (N1) to compute the Public-Key (P1), wherein the Function (F1) comprises a key derivation function and the Public-Key (P1) comprises a credential wrapping key (CWK) (220);
generating, by a hardware security module (106) of the mobile device (100), a credential private key (CPK) (222) such that the private half of the credential private key (CPK) (222) is hardware-bound, non-extractable, and never leaves the hardware security module (106) in plaintext, and binding use of the credential private key (CPK) (222) to the Public-Key (P1) by wrapping a credential record referencing the credential private key (CPK) (222) using the Public-Key (P1) as a key encryption key, and storing the wrapped credential record in non-volatile storage of the mobile device (100);
storing the Unique-Number (N1) on the mobile device (100) and transmitting the Unique-Number (N1) and a credential public key derived from the credential private key (CPK) (222) to a relying party server (114) via a network (112);
storing, by the relying party server (114), the Unique-Number (N1) in a deduplication database (118) of the relying party server (114) and the credential public key in an account store (120) of the relying party server (114);
authenticating the user in a subsequent authentication ceremony by:
capturing a fresh biometric sample from the user in real-time, processing the fresh biometric sample in transient volatile memory of the application's process to compute a fresh Secret-Key (S2), retrieving the stored Unique-Number (N1), applying the Function (F1) to the fresh Secret-Key (S2) and the retrieved Unique-Number (N1) to compute a Real-Time-Public-Key (P2), wherein equivalence of the Real-Time-Public-Key (P2) to the originally-computed Public-Key (P1) is demonstrated by successful unwrapping of the stored wrapped credential record using the Real-Time-Public-Key (P2), recovering from the unwrapped credential record a credential identifier referencing the credential private key (CPK) (222), and producing, by the hardware security module (106), a digital signature over a digest supplied by the application processor (104) using the hardware-bound credential private key (CPK) (222) referenced by the recovered credential identifier; and
enforcing, by the relying party server (114), Sybil resistance by checking the deduplication database (118) for an existing entry matching the Unique-Number (N1) upon any credential registration attempt, and rejecting the credential registration attempt when a matching entry is found and the credential registration attempt does not include a recovery indicator.

24. A computer program product for generating and managing a biometrically-authenticated credential key anchored to an identity record, the computer program product comprising a non-transitory computer-readable storage medium having program instructions embodied therewith, wherein the program instructions are executable by at least one processor to perform operations comprising a refinement of a biometric-authentication construct in which a Secret-Key (S1) is computed from a biometric sample, a Unique-Number (N1) is obtained, and a Public-Key (P1) is computed as P1=F1(S1, N1) by application of a Function (F1), the operations comprising:
capturing a biometric sample from a user in real-time using a biometric sensor (102) of a mobile device (100);
processing the captured biometric sample, by an application processor (104) of the mobile device (100) in transient volatile memory of an application's process, to compute the Secret-Key (S1) corresponding to the user, wherein the Secret-Key (S1) comprises a proprietary biometric key (PBK) (206) computed by processing the captured biometric sample;
extracting, via an identity-anchor record acquisition module (108) of the mobile device (100), attribute fields from an identity-anchor record (110) presented by the user, cryptographically verifying, by the identity-anchor record acquisition module (108), the identity-anchor record (110) against a digital signature of an issuer of the identity-anchor record (110) using a public key or a certificate chain of the issuer, and aborting the credential creation ceremony when the cryptographic verification fails, canonicalizing the extracted attribute fields, and obtaining the Unique-Number (N1) corresponding to the user, wherein the Unique-Number (N1) comprises a deterministic document hash (DocHash) (216) computed by applying a cryptographic hash function to a canonical byte representation of the canonicalized attribute fields with a domain separator, and wherein the Unique-Number (N1) is deterministically computed from the identity-anchor record (110) in lieu of being generated by a random number generation algorithm;
applying, by the application processor (104) in transient volatile memory of the application's process, the Function (F1) to the Secret-Key (S1) and the Unique-Number (N1) to compute the Public-Key (P1), wherein the Function (F1) comprises a key derivation function and the Public-Key (P1) comprises a credential wrapping key (CWK) (220);
generating, by a hardware security module (106) of the mobile device (100), a credential private key (CPK) (222) such that the private half of the credential private key (CPK) (222) is hardware-bound, non-extractable, and never leaves the hardware security module (106) in plaintext, and binding use of the credential private key (CPK) (222) to the Public-Key (P1) by wrapping a credential record referencing the credential private key (CPK) (222) using the Public-Key (P1) as a key encryption key, and storing the wrapped credential record in non-volatile storage of the mobile device (100);
storing the Unique-Number (N1) on the mobile device (100) and transmitting the Unique-Number (N1) and a credential public key derived from the credential private key (CPK) (222) to a relying party server (114) via a network (112) for storage in a deduplication database (118) and an account store (120) of the relying party server (114), respectively;
authenticating the user in a subsequent authentication ceremony by capturing a fresh biometric sample, computing a fresh Secret-Key (S2), retrieving the stored Unique-Number (N1), applying the Function (F1) to the fresh Secret-Key (S2) and the retrieved Unique-Number (N1) to compute a Real-Time-Public-Key (P2), unwrapping the stored wrapped credential record using the Real-Time-Public-Key (P2), recovering a credential identifier referencing the credential private key (CPK) (222), and producing, by the hardware security module (106), a digital signature using the hardware-bound credential private key (CPK) (222) referenced by the recovered credential identifier; and
causing the relying party server (114) to check the deduplication database (118) for an existing entry matching the Unique-Number (N1) upon any credential registration attempt, and to reject the credential registration attempt when a matching entry is found and the credential registration attempt does not include a recovery indicator.
